(19) United States
(12) Patent Application Publication
(10) Pub. No.: US 2022/0337019 A1
(43) Pub. Date: Oct. 20, 2022

(54) SINGLE PUMP, MULTIPLE STAGE POWER AMPLIFIER IN LIDAR APPLICATION

(71) Applicant: Innovusion, Inc., Sunnyvale, CA (US)

(72) Inventor: Peng Wan, Fremont, CA (US)

(73) Assignee: Innovusion, Inc., Sunnyvale, CA (US)

(21) Appl. No.: 17/724,251

(22) Filed: Apr. 19, 2022

Related U.S. Application Data
(60) Provisional application No. 63/177,375, filed on Apr. 20, 2021.

(51) Int. Cl. H01S 3/091; H01S 3/067; H01S 3/23; G01S 17/931; G01S 7/481

(52) U.S. Cl. CPC H01S 3/091; H01S 3/06754; H01S 3/2316; G01S 17/931; G01S 7/4814; G01S 7/4817

(57) ABSTRACT

A multiple stage optical amplification device in a light detection and ranging (LiDAR) scanning system is provided. The system comprises a first power amplification stage receiving seed laser light and outputting first amplified laser light; a second power amplification stage receiving the first amplified laser light and outputting a second amplified laser light; and a single optical power pump coupled to the second power amplification stage. The second power amplification stage is configured to amplify the first amplified laser light to generate the second amplified laser light. A first portion of pump power provided by the optical power pump is deliverable to the first power amplification stage to amplify the seed laser light.

### CROSS-REFERENCE TO RELATED APPLICATIONS

This application claims priority to U.S. Provisional Patent Application Ser. No. 63/177,375, filed Apr. 20, 2021, entitled “SINGLE PUMP, MULTIPLE STAGE POWER AMPLIFIER IN LIDAR APPLICATION,” the content of which is hereby incorporated by reference in its entirety for all purposes.

### FIELD OF THE TECHNOLOGY

This disclosure relates generally to laser power amplification and, more particularly, to a multiple stage laser amplification device used in a light detection and ranging (LiDAR) scanning system.

### BACKGROUND

Light detection and ranging (LiDAR) systems use light pulses to create an image or point cloud of the external environment. Some typical LiDAR systems include a light source, a light transmitter, a light steering system, and a light detector. The light source generates a light beam that is directed by the light steering system in particular directions when being transmitted from the LiDAR system. When a transmitted light beam is scattered by an object, a portion of the scattered light returns to the LiDAR system as a return light pulse. The light detector detects the return light pulse. Using the difference between the time that the return light pulse is detected and the time that a corresponding light pulse in the light beam is transmitted, the LiDAR system can determine the distance to the object using the speed of light. The light steering system can direct light beams along different paths to allow the LiDAR system to scan the surrounding environment and produce images or point clouds. LiDAR systems can also use techniques other than time-of-flight and scanning to measure the surrounding environment.

### SUMMARY

Systems and methods described in this disclosure provide an amplification device having multiple amplification stages. The multiple amplification stages share a single power pump. At least a portion of the power provided by the single power pump propagates backward from the second or later amplification stage to the first amplification stage. As a result, the disclosed optical amplification devices have less complex structure, fewer components, higher reliability, and higher operational efficiency than a conventional multiple stage optical amplifier. The disclosed optical amplification devices retain or improve the multiple stage amplification device's capability of reducing Amplified Spontaneous Emission (ASE) and noise.

In one embodiment, a multiple stage optical amplification device in a light detection and ranging (LiDAR) scanning system is provided. The device comprises a first power amplification stage receiving seed laser light and outputting first amplified laser light; a second power amplification stage receiving the first amplified laser light and outputting a second amplified laser light; and a single optical power pump coupled to the second power amplification stage. The second power amplification stage is configured to amplify the first amplified laser light to generate the second amplified laser light. A first portion of pump power provided by the optical power pump is deliverable to the first power amplification stage to amplify the seed laser light.

In one embodiment, a multi-stage laser amplification device in a light detection and ranging (LiDAR) scanning system is provided. The device comprises a first power amplification stage receiving a seed laser light and outputting a first amplified laser light; a second power amplification stage receiving the first amplified laser light and outputting a second amplified laser light; a third power amplification stage receiving the second amplified laser light and outputting a third amplified laser light; and a single optical power pump coupled to the third power amplification stage. The third power amplification stage amplifies the second amplified laser light. A first portion of pump power provided by the optical power pump is deliverable to the first power amplification stage.

A method performed by a multiple stage optical amplification device for performing optical amplification is provided. The method comprises receiving seed laser light; generating, by a single optical power pump, pump laser light to provide pump power; amplifying, by a first power amplification stage, the seed laser light using a first portion of the pump power to generate a first amplified laser light; and amplifying, by a second power amplification stage, the first amplified laser light using a second portion of the pump power to generate a second amplified laser light. The first portion of the pump power is delivered from the second power amplification stage to the first power amplification stage to amplify the seed laser light.

### BRIEF DESCRIPTION OF THE DRAWINGS

The present application can be best understood by reference to the figures described below taken in conjunction with the accompanying drawing figures, in which like parts may be referred to by like numerals.

FIG. 1 illustrates one or more exemplary LiDAR systems disposed or included in a motor vehicle.

FIG. 2 is a block diagram illustrating interactions between an exemplary LiDAR system and multiple other systems including a vehicle perception and planning system.

FIG. 3 is a block diagram illustrating an exemplary LiDAR system.

FIG. 4 is a block diagram illustrating an exemplary fiber-based laser source.

FIGS. 5A-5C illustrate an exemplary LiDAR system using pulse signals to measure distances to objects disposed in a field-of-view (FOV).

FIG. 6 is a block diagram illustrating an exemplary apparatus used to implement systems, apparatus, and methods in various embodiments.

FIG. 7 illustrates a prior art single stage pre-amplifier.

FIG. 8 illustrates a multiple stage optical amplification device having a forward-pumping and backward-pumping configuration according to some embodiments.

FIG. 9 illustrates a multiple stage optical amplification device having a backward-pumping and backward-pumping configuration according to some embodiments.

FIG. 10 illustrates a multiple stage optical amplification device having a forward-pumping and forward-pumping configuration according to some embodiments.

FIG. 11 illustrates a multiple stage optical amplification device having a backward-pumping and forward-pumping configuration according to some embodiments.

FIG. 12 illustrates a multiple stage optical amplification device having three amplification stages according to some embodiments.

FIG. 13 illustrates various embodiments of a light coupling unit used in a multiple stage laser amplification device.

FIG. 14 illustrates example relations between an output power and a pump current of both a single stage optical amplifier and a multiple stage optical amplification device.

FIG. 15 is a flowchart illustrating a process of amplifying seed laser light using a disclosed multiple amplification stage device.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

Throughout the following disclosure, numerous references may be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, PLD, DSP, x86, ARM, RISC-V, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable medium storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, etc.). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

An optical amplifier is a device that amplifies an optical signal to increase the signal power. One type of optical amplifiers uses a doped optical fiber as a gain medium to amplify an optical signal. They are often used in fiber-based laser systems. In a typical optical amplifier, a seed laser generates the optical signals to-be-amplified. An optical power pump may be a pump laser (e.g., laser diodes) that provides optical pump power. The optical signals to-be-amplified and the pump laser are multiplexed by, for example, a wavelength division multiplexer (WDM) into a doped optical fiber. The optical signals are thus amplified through interaction with the dopant ions. Amplification is achieved by stimulated emission of photons from dopant ions in the doped optical fiber. The pump laser provides optical pump power to excite dopant ions into an upper energy level from where they can decay via stimulated emission of a photon at the desired signal wavelength back to a lower energy level.

In a typical optical amplifier having a single optical power pump, the optical power pump and the seed laser are both disposed in front of the WDM so their outputs are provided to, and combined by, the WDM. If such an optical amplifier is required to provide a high output power (e.g., 100 mW or higher), the optical amplifier may need to have a power gain that is sufficiently high in order to meet the output power requirement. A high output power is often desirable in LiDAR applications. For example, an optical signal having high output power enables the LiDAR to detect objects located at a farther distance and/or to receive a return signal having a good signal-to-noise ratio (SNR). The high-power gain of the optical amplifier, however, may also amplify noise together with the optical signals. One type of such noise is amplified spontaneous emission (ASE), which has a spectrum approximately the same as the gain spectrum of the optical amplifier. As described above, amplification of optical signals is achieved by decaying via stimulated emission. But electrons in the upper energy level can also decay by spontaneous emission, which occurs randomly. Photons are emitted spontaneously in all directions, but a proportion of those will be emitted in a direction that falls within the numerical aperture of the optical fiber and are thus captured and guided by the optical fiber. Those photons captured may then interact with other dopant ions and are thus amplified by the stimulated emission. The initial spontaneous emission is therefore amplified in the same manner as the signals, and is referred to as the Amplified Spontaneous Emission. ASE is emitted by the fiber-based amplifier in both the forward and reverse directions. The forward ASE may cause negative impact to system performance because noise will co-propagate with the signal to the receiver where it can degrade system performance. Counter-propagating ASE can lead to degradation of the amplifier's performance since the ASE can deplete the inversion level and thereby reduce the gain of the amplifier and increase the noise produced relative to the desired signal gain.

To reduce the impact of the ASE, multi-stage optical amplifiers are used in laser systems. A multi-stage optical amplifier comprises multiple optical power pumps. Using a two-stage optical amplifier as an example, it typically includes a first optical power pump and a second optical power pump. The first optical power pump and the seed laser are disposed in front of a WDM or combiner, which combines seed laser and the pump laser into a doped fiber. As a result, the seed laser is amplified in the first stage. The amplified laser light may then be delivered to a second stage, where another WDM or combiner combines the amplified laser light with the pump laser provided by the second optical power pump. Thus, the amplified laser light is further amplified to produce output laser light that has a required output power. Because the amplification is performed in multiple stages using multiple optical power pumps, the gain for each amplification stage can be smaller, thereby reducing the ASE.

While multi-stage amplifiers reduce ASE and therefore can provide a better SNR, they tend to have complex structures that cause assembly difficulties in a manufacturing process. Moreover, they have a somewhat greater number of components and therefore may be less reliable, particularly when they are used in or integrated with LiDAR systems. A LiDAR system is often mounted in a vehicle, which may experience a large variety of different environmental conditions (e.g., high or low temperatures, high or low humidity, vibrations, shock, dirty conditions, or the like). As such, the LiDAR system is often required to be reliable and robust so that it can function properly under different environmental conditions. An optical amplifier having many components may increase the risk of performance degradation or even system failure if one or more of the components fail to perform or underperform. Therefore, an optical amplifier having many components may be less reliable. Moreover, a typical optical amplifier tends to have lower operational efficiency because a non-insignificant portion of the pump power may be wasted.

Systems and methods described in this disclosure provide embodiments of optical amplifiers having multiple amplification stages using a single optical power pump. The disclosed optical amplifiers make more efficient use of the pump power and reduces energy waste by delivering the portion of the pump power that is unused by the second amplification stage to the first amplification stage. Moreover, the disclosed optical amplifiers have less complex structure, fewer components, higher reliability, and higher operational efficiency, while retaining or improving the benefit of reduced ASE and noise. Embodiments of present invention are described below in details.

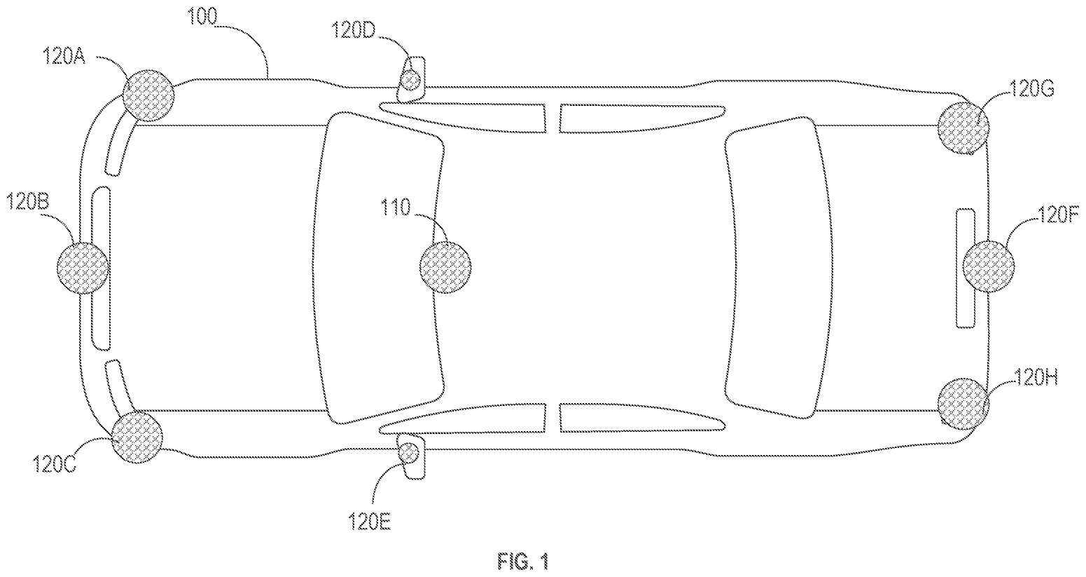

FIG. 1 illustrates one or more exemplary LiDAR systems 110 disposed or included in a motor vehicle 100. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-F. Each of LiDAR systems 110 and 120A-F can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is often an essential sensor of a vehicle that is at least partially automated. In one embodiment, as shown in FIG. 1, motor vehicle 100 may include a single LiDAR system 110 (e.g., without LiDAR systems 120A-F) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-F. As shown in FIG. 1, in one embodiment, multiple LiDAR systems 110 and/or 120A-F are attached to vehicle 100 at different locations of the vehicle. For example, LiDAR system 120A is attached to vehicle 100 at the front right corner; LiDAR system 120B is attached to vehicle 100 at the front center; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; and/or LiDAR system 120F is attached to vehicle 100 at the back center. In some embodiments, LiDAR systems 110 and 120A-F are independent LiDAR systems having their own respective laser sources, control electronics, transmitters, receivers, and/or steering mechanisms. In other embodiments, some of LiDAR systems 110 and 120A-F can share one or more components, thereby forming a distributed sensor system. In one example, optical fibers are used to deliver laser light from a centralized laser source to all LiDAR systems. It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

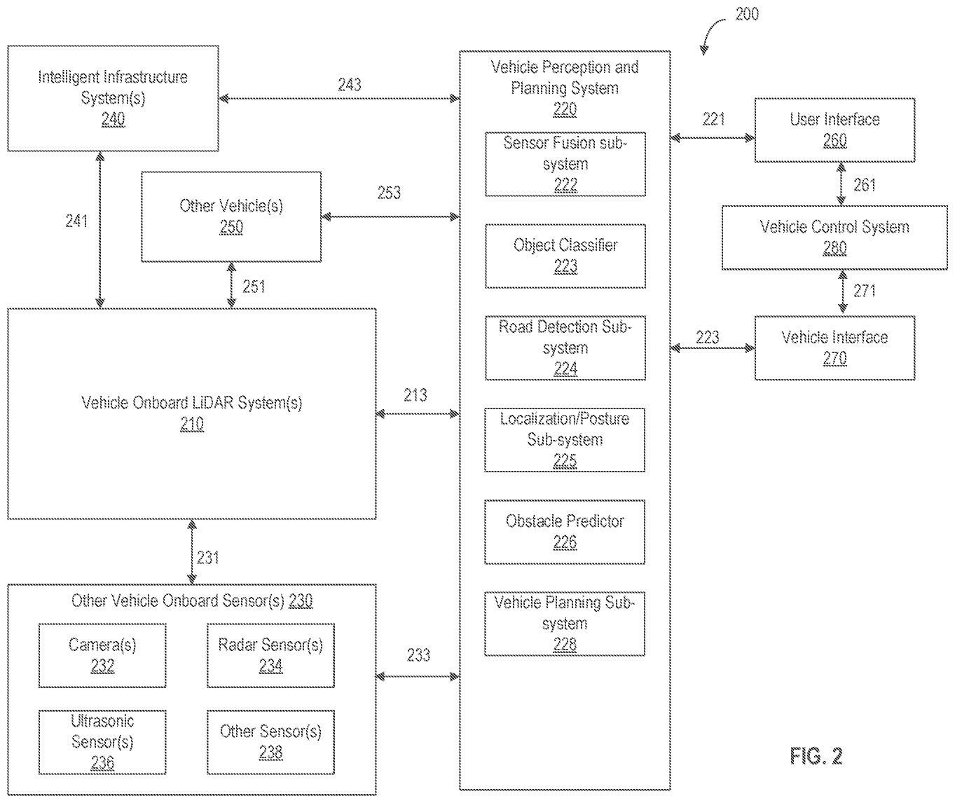

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-40 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 100-150 meters from the LiDAR sensor. Medium-range LiDAR sensors can be used for, e.g., monitoring road intersections, assistance for merging onto or leaving a freeway, or the like. A long-range LiDAR sensor measures objects located up to about 150-300 meters. Long-range LiDAR sensors are typically used when a vehicle is travelling at high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are used to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera produces monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data.

Other vehicle onboard sensor(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations.

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, check blind spot, identify parking spots, provide lane changing assistance into traffic, or the like. Sensor data generated by ultrasonic sensor(s) 236 can also be provided to vehicle perception and planning system 220 via communication path 233 for further processing and controlling the vehicle operations.

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud service for processing and then the processing results can be transmitted back to the vehicle perception and planning system 220).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is a behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210, thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffics in the opposite direction. In such a situation, sensors of intelligent infrastructure system(s) 240 can provide useful, and sometimes vital, data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can detect and classify the objects and estimate the positions of the objects. In some embodiments, object classifier 233 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network-based models, encoder-decoder RNN models, or the like.

With reference still to FIG. 2, in some embodiments, vehicle perception and planning system 220 further comprises vehicle planning sub-system 228. Vehicle planning sub-system 228 can include a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle's steering mechanism, throttle, brake, etc., to operate the vehicle according to the planned route and movement. Vehicle perception and planning system 220 may further comprise a user interface 260, which provides a user (e.g., a driver) access to vehicle control system 280 to, for example, override or take over control of the vehicle when necessary. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

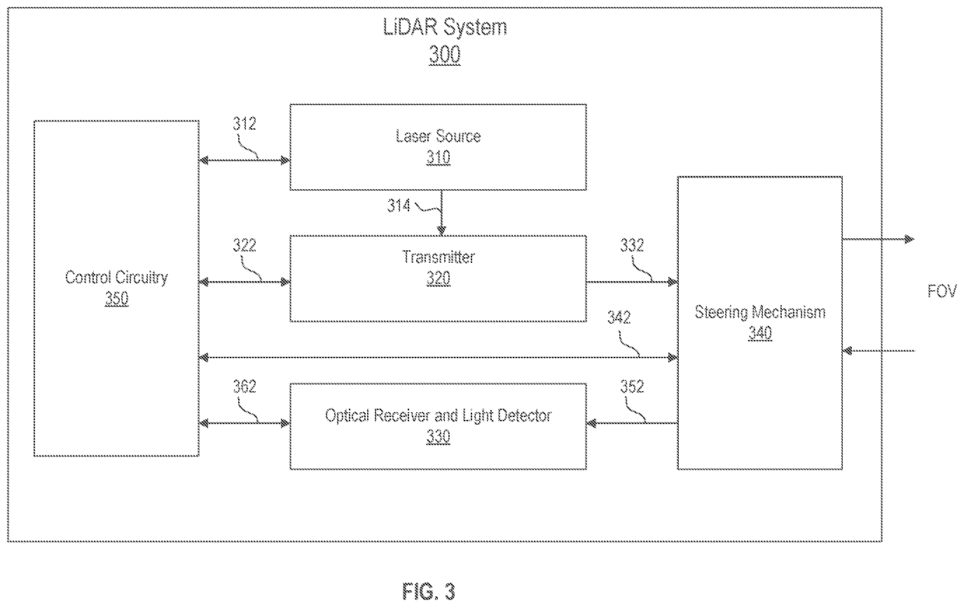

FIG. 3 is a block diagram illustrating an exemplary LiDAR system 300. LiDAR system 300 can be used to implement LiDAR system 110, 120A-F, and/or 210 shown in FIGS. 1 and 2. In one embodiment, LiDAR system 300 comprises a laser source 310, a transmitter 320, an optical receiver and light detector 330, a steering system 340, and a control circuitry 350. These components are coupled together using communications paths 312, 314, 322, 332, 343, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between laser source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Laser source 310 outputs laser light for illuminating objects in a field of view (FOV). Laser source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high-power fiber laser source.

In some embodiments, laser source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a solid-state bulk laser or a tunable external-cavity diode laser. In some embodiments, laser source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals.

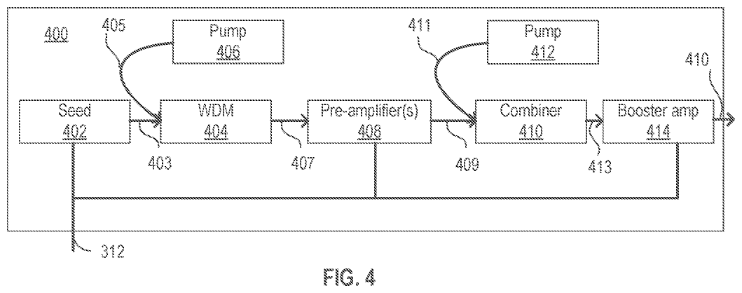

FIG. 4 is a block diagram illustrating an exemplary fiber-based laser source 400 having a seed laser and one or more pumps (e.g., laser diodes) for pumping desired output power. Fiber-based laser source 400 is an example of laser source 310 depicted in FIG. 3. In some embodiments, fiber-based laser source 400 comprises a seed laser 402 to generate initial light pulses of one or more wavelengths (e.g., 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 into a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 20-30 dB gain). In some embodiments, pre-amplifier(s) 408 are low noise amplifiers. Pre-amplifier(s) 408 output to a combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides pulses to a booster amplifier 414, which produces output light pulses via optical fiber 410. The booster amplifier 414 provides further amplification of the optical signals. The outputted light pulses can then be transmitted to transmitter 320 and/or steering mechanism 340 (shown in FIG. 3). It is understood that FIG. 4 illustrates one exemplary configuration of fiber-based laser source 400. Laser source 400 can have many other configurations using different combinations of one or more components shown in FIG. 4 and/or other components not shown in FIG. 4 (e.g., other components such as power supplies, lens, filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based light source 400. Fiber-based light source 400 can also include other components not shown, such as one or more power connectors, power supplies, and/or power lines.

Referencing FIG. 3, typical operating wavelengths of laser source 310 comprise, for example, about 850 nm, about 905 nm, about 940 nm, about 1064 nm, and about 1550 nm. The upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from laser source 310 can be characterized by its peak power, average power, and the pulse energy. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. The PRR typically corresponds to the maximum range that a LiDAR system can measure. Laser source 310 can be configured to produce pulses at high PRR to meet the desired number of data points in a point cloud generated by the LiDAR system. Laser source 310 can also be configured to produce pulses at medium or low PRR to meet the desired maximum detection distance. Wall plug efficiency (WPE) is another factor to evaluate the total power consumption, which may be a key indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring laser source 310 and/or designing laser delivery systems for vehicle-mounted LiDAR applications.

It is understood that the above descriptions provide non-limiting examples of a laser source 310. Laser source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Laser source 310 provides laser light (e.g., in the form of a laser beam) to transmitter 320. The laser light provided by laser source 310 can be amplified laser light with a predetermined or controlled wavelength, pulse repetition rate, and/or power level. Transmitter 320 receives the laser light from laser source 310 and transmits the laser light to steering mechanism 340 with low divergence. In some embodiments, transmitter 320 can include, for example, optical components (e.g., lens, fibers, mirrors, etc.) for transmitting laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by laser source 310 may diverge as they travel to transmitter 320. Therefore, transmitter 320 often comprises a collimating lens configured to collect the diverging laser beams and produce parallel optical beams with reduced or minimum divergence. The parallel optical beams can then be further directed through various optics such as mirrors and lens. A collimating lens may be, for example, a plano-convex lens. The collimating lens can be configured to have any desired properties such as the beam diameter, divergence, numerical aperture, focal length, or the like. A beam propagation ratio or beam quality factor (also referred to as the M² factor) is used for measurement of laser beam quality. In many LiDAR applications, it is important to control good laser beam quality in generated a transmitting laser beam. The M² factor represents a degree of variation of a beam from an ideal Gaussian beam. Thus, the M² factor reflects how well a collimated laser beam can be focused on a small spot, or how well a divergent laser beam can be collimated. The smaller the M² factor, the tighter the focus of the laser beam and the more intense a beam spot can be obtained. Therefore, laser source 310 and/or transmitter 320 can be configured to obtained desired M² factor according to, for example, a scan resolution requirement.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. Steering mechanism 340 will be described in more detail below. The laser light scanned to an FOV may be scattered or reflected by an object in the FOV. At least a portion of the scattered or reflected light returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focus, amplifying, and/or filtering return light from the FOV. For example, the optical receiver often includes a receiver lens or focusing lens (e.g., a plano-convex lens) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One exemplary method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, a APD (avalanche photodiode) based structure, a PMT (photomultiplier tube) based structure, a SiPM (Silicon photomultiplier) based structure, a SPAD (single-photon avalanche diode) base structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise (TIA). In some embodiments, optical receiver and light detector 330 may include a pre-amplifier that is a low noise amplifier (LNA). In some embodiments, the pre-amplifier may also include a TIA-transimpedance amplifier, which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implement signal processing techniques (e.g., filtering, noise reduction, amplification, or the like). For example, in addition to or instead of using direct detection of return signals (e.g., by using TOF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism or a scanning mechanism. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include MEMS mirror-based steering, optical phased arrays based steering, and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an exemplary non-scanning LiDAR system).

Steering mechanism 340 can be used with the transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or two devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s) for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lens) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling laser source 310 to obtain desired laser pulse timing, repetition rate, and power; controlling steering mechanism 340 (e.g., controlling the speed, direction, and/or other parameters) to scan the FOV and maintain pixel registration/alignment; controlling optical receiver and light detector 330 (e.g., controlling the sensitivity, noise reduction, filtering, and/or other parameters) such that it is an optimal state; and monitoring overall system health/status for functional safety.

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; and/or determines any other type of data relevant to LiDAR system 300.

LiDAR system 300 can be disposed in a vehicle, which may operate in many different environments including hot or cold weather, rough road conditions that may cause intense vibration, high or low humidifies, dusty areas, etc. Therefore, in some embodiments, optical and/or electronic components of LiDAR system 300 (e.g., optics in transmitter 320, optical receiver and light detector 330, and steering mechanism 340) are disposed or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one exemplary LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

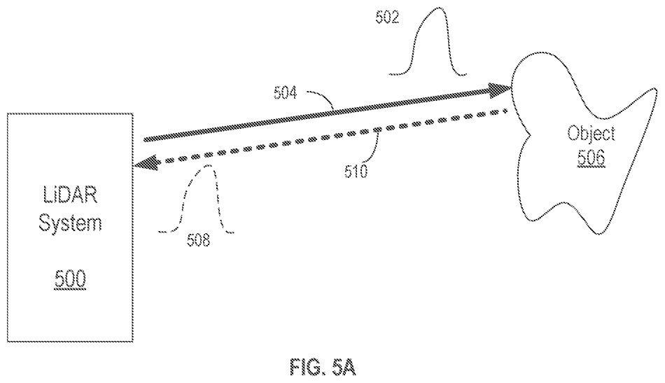

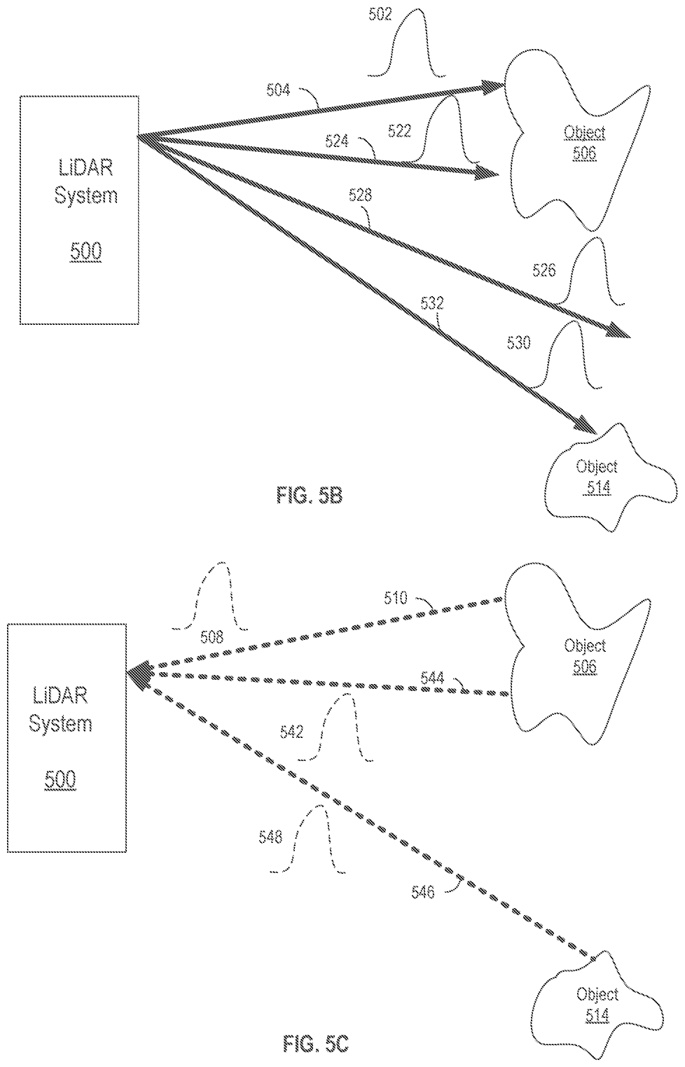

As described above, some LiDAR systems use the time-of-flight (TOF) of light signals (e.g., light pulses) to determine the distance to objects in a light path. For example, with reference to FIG. 5A, an exemplary LiDAR system 500 includes a laser light source (e.g., a fiber laser), a steering system (e.g., a system of one or more moving mirrors), and a light detector (e.g., a photon detector with one or more optics). LiDAR system 500 can be implemented using, for example, LiDAR system 300 described above. LiDAR system 500 transmits a light pulse 502 along light path 504 as determined by the steering system of LiDAR system 500. In the depicted example, light pulse 502, which is generated by the laser light source, is a short pulse of laser light. Further, the signal steering system of the LiDAR system 500 is a pulsed-signal steering system. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to generate a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are generated by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then it may be determined that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source with a higher pulse repetition rate (PRR) is needed. On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an exemplary LiDAR system that can transmit laser pulses with a repetition rate between 500 kHz and 1 MHz. Based on the time it takes for a pulse to return to the LiDAR system and to avoid mix-up of return pulses from consecutive pulses in a conventional LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

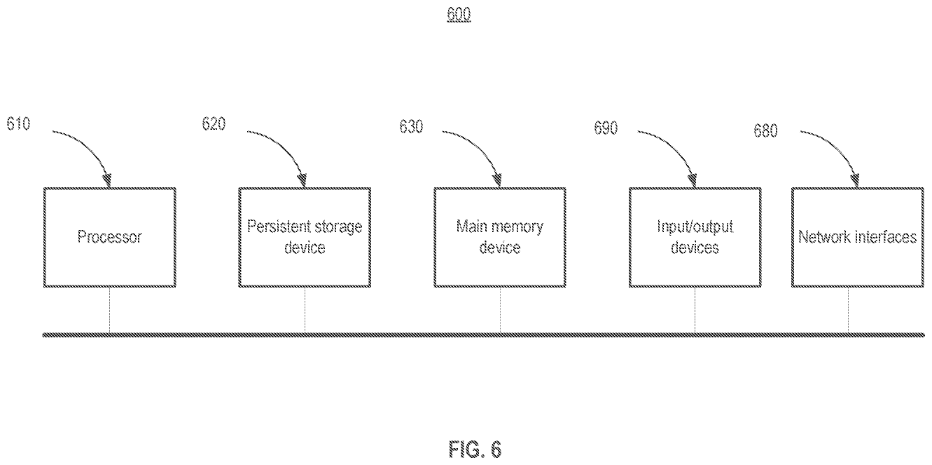

A high-level block diagram of an exemplary apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps described herein can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps described herein. Accordingly, by executing the computer program instructions, the processor 610 executes an algorithm defined by the methods described herein. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

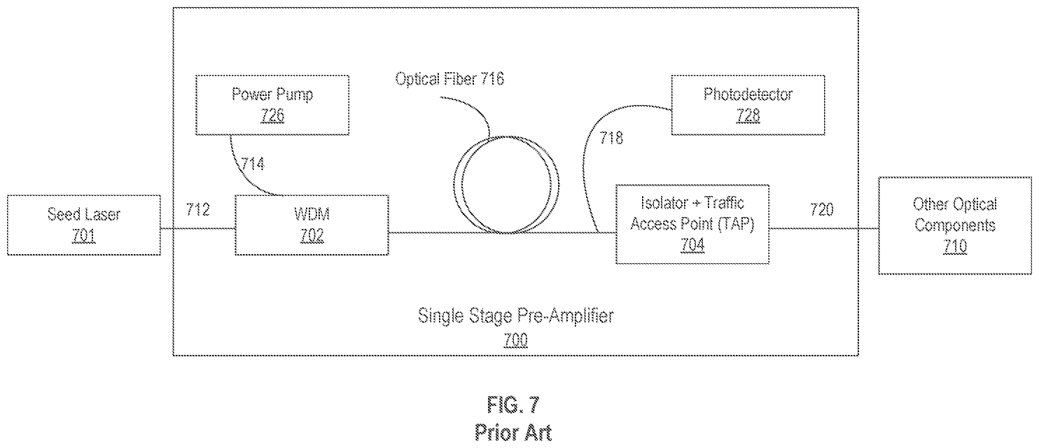

FIG. 7 illustrates a conventional single stage pre-amplifier 700. Single stage pre-amplifier 700 comprises a wavelength division multiplexer (WDM) 702, an optical power pump 726, an optical fiber 716, an optical isolator and TAP (traffic access point) unit 704, and a photodetector 728. Single stage pre-amplifier 700 receives optical signals provided by seed laser 701 via optical fiber 712. These optical signals are to be amplified by single stage pre-amplifier 700. Optical power pump 726 (e.g., laser diodes) provides a pump laser, which is carried by optical fiber 714. The optical signals to be amplified and the pump laser are multiplexed by, for example, WDM 702 into a doped optical fiber 716. The optical signals are thus amplified through interaction with the dopant ions in optical fiber 716. Amplification is achieved by stimulated emission of photons from dopant ions in optical fiber 716. In particular, the pump laser excites ions into an upper energy level from where they can decay via stimulated emission of a photon at the signal wavelength back to a lower energy level.

The doped optical fiber 716 is optically coupled to optical isolator and TAP (traffic access point) unit 704 and photodetector 728. The optical isolator and TAP unit 704 includes an optical isolator that allows optical signal to travel only in one direction. For example, the optical isolator allows the amplified optical signals to travel from optical fiber 716 to other optical components 710 but not backward. Thus, the optical isolator prevents undesired feedback or reflection. The TAP is an access point that provides real-time monitoring of the optical signals. Photodetector 728 receives at least a portion of the amplified optical signals via optical fiber 718 and provides measurements of the output power of the amplified optical signals. The amplified optical signals pass through isolator and TAP unit 704 and are delivered to other optical components 710 (e.g., lens, mirrors, etc.). As described above, if single stage pre-amplifier 700 is required to provide a high output power (e.g., 100 mW or higher), it needs to have a power gain that is sufficiently high in order to meet the output power requirement. The high power gain results in amplification of ASE, thereby degrading the system's performance because noise will co-propagate with the optical signals in the forward direction.

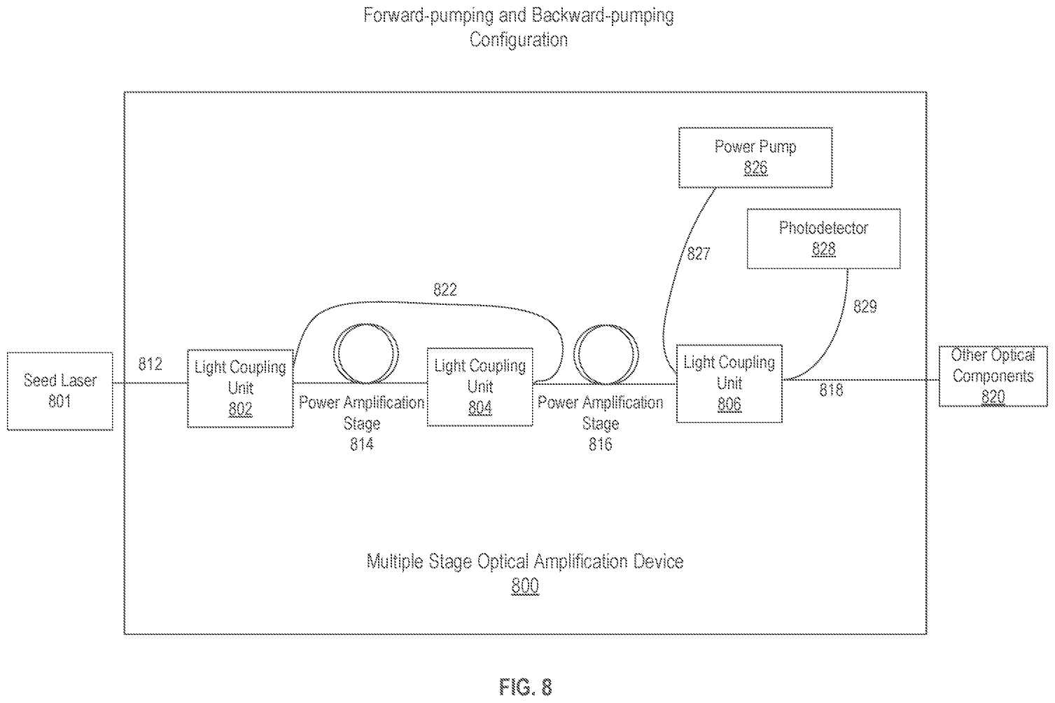

FIG. 8 illustrates a multiple stage optical amplification device 800 having a forward-pumping and backward-pumping configuration according to some embodiments. Multiple stage optical amplification device 800 comprises light coupling units 802, 804, and 806, power amplification stages 814 and 816, a single optical power pump 826, photodetector 828, a fiber-based delivering medium 822, and optical paths 812, 818, 827, and 829. Device 800 is a two-stage amplification device having a single optical power pump. In one embodiment, light coupling unit 802 is optically coupled to seed laser 801 via optical path 812. Seed laser 801 includes a master oscillator that can provide continuous wave laser light or pulsed laser light. As one example, seed laser 801 can be configured to generate pulsed laser light having one or more wavelengths (e.g., 1550 nm). Optical path 812 can include an optical fiber and/or one or more free-space optics (e.g., lens) for delivering the seed laser light from seed laser 801 to light coupling unit 802.

In addition to being coupled to seed laser 801, light coupling unit 802 is optically coupled to a first end (e.g., the front end) of power amplification stage 814 and a first end of a fiber-based delivering medium 822, as shown in FIG. 8. The first end of fiber-based delivering medium 822 is optically coupled to the front end of first power amplification stage 814 via light coupling unit 802. The second end of fiber-based delivering medium 822 is optically coupled to a first end (e.g., the front end) of second power amplification stage 816 via light coupling unit 804. Light coupling unit 804 is also optically coupled to the second end (e.g., the backend) of power amplification stage 814. Light coupling unit 804 is further optically coupled to a first end (e.g., the front end) of another power amplification stage 816. The second end (e.g., the backend) of power amplification stage 816 is optically coupled to an optical power pump 826 via another light coupling unit 806.

In device 800, power amplification stages 814 and 816 each comprise a fiber-based amplification medium such as a rare earth doped optical fiber. Such an optical fiber can be, for example, a fiber doped with at least one of Ytterbium (Yb), Erbium (Er), Thulium (Tm), or Neodymium (Nd). The fiber-based amplification media included in power amplification stages 814 and 816 may be the same or different. For example, each of amplification stages 814 and 816 may comprise a 1550 nm single mode Er-doped optical fiber. Optical power pump 826 can provide pump laser light using, for example, one or more laser diodes. In one example, the optical power pump is a 400 mW single mode pump producing pump laser light having a 980 nm wavelength. It is understood that power amplification stages 814 and 816 can include any type of doped medium to produce output light having any desired wavelengths (e.g., 1030 nm, 1064 nm, 1530 nm, 1550 nm, 2 μm, or the like). In addition, optical power pump 826 can also be configured to provide pump laser light having any desired wavelength (e.g., 915 nm, 940 nm, 980 nm, 1530 nm, or the like). Further, the fiber-based amplification media used in the power amplification stages (e.g., stages 814 and 816) can comprise single mode fibers, large mode area (LMA) fibers, double-clad fibers, or the like. The pump laser light may have a wavelength that is different from, or the same as, the seed laser light generated by seed laser 801.

Unlike device 700, in which optical power pump 726 is disposed at the front end of the power amplifier, optical power pump 826 of device 800 is disposed at the backend of power amplification stage 816. In this configuration shown in FIG. 8, optical power pump 826 can provide pump power to both power amplification stages 814 and 816. As shown in FIG. 8, optical power pump 826 is optically coupled to the backend of power amplification stage 816 via light coupling unit 806. Optical power pump 826 generates pump laser light to provide pump power. The pump power provided by optical power pump 826 is delivered to light coupling unit 806 via optical path 827 (e.g., an optical fiber). Light coupling unit 806 delivers the pump laser light to power amplification stage 816 to provide pump power. A portion of the pump power is used in power amplification stage 816 for amplification and another portion of the pump power is delivered to light coupling unit 804. Light coupling unit 804 then provides a portion of the pump power to light coupling unit 802 using fiber-based delivering medium 822. Light coupling unit 802 combines seed laser light with the portion of the pump power (in the form of pump laser light) delivered by fiber-based delivering medium 822.

As shown in FIG. 8, light coupling unit 802 is optically coupled to the front end of power amplification stage 814. Thus, the combined seed laser light and the portion of the pump power delivered by fiber-based delivering medium 822 are delivered to power amplification stage 814. The portion of the pump power delivered by fiber-based delivering medium 822 can thus be used to amplify the seed laser light in power amplification stage 814. Amplification can be obtained by stimulated emission of photons from dopant ions in the doped optical fiber used in power amplification stage 814. In particular, the portion of the pump power delivered by fiber-based delivering medium 822 excites ions into an upper energy level from where they can decay via stimulated emission of a photon at the desired signal wavelength back to a lower energy level. As a result, power amplification stage 814 is a first amplification stage that amplifies the seed laser light and generates the first amplified laser light.

Next, light coupling unit 804 delivers the first amplified laser light to power amplification stage 816, which uses a portion of the pump power provided by optical power pump 826 via light coupling unit 806. The first amplified laser light is thus further amplified in a similar manner. In particular, a portion of the pump power provided by optical power pump 826 is absorbed by the doped optical fiber of power amplification stage 816 to excite dopant ions. The decay of the excited ions from an upper energy level to a lower energy level generates a second amplified laser light having the desired signal wavelength (e.g., 1550 nm).

In one example, about 50-90% (e.g., 70%) of the pump power provided by the optical power pump 826 is used for the second stage amplification performed by power amplification stage 816. The remaining about 10-50% (e.g., 30%) of the pump power is delivered to the power amplification stage 814 and is used for the first stage amplification. Thus, the configuration of device 800 shown in FIG. 8 can use a single optical power pump to provide two stage amplifications. Device 800 therefore makes more efficient use of the pump power and reduces energy waste by delivering the portion of the pump power that is unused by the second amplification stage to the first amplification stage. In one example, the output power of the output signal from device 800 is about 40% higher than a single stage amplifier such as the one shown in FIG. 7. A higher output power enables the signal light to travel to a far-distance object. As a result, a LiDAR device using such a signal light can detect object that is located far away from the device (e.g., more than about 100-150 meters). Device 800 also does not require to use a laser light splitter for splitting the pump laser light to be used in two amplification stages, thereby reducing the number of required optical components. Device 800 also does not require other additional optical components (e.g., pump power strippers), therefore enhancing the hardware integration. The reduced number of optical components enhances the system robustness and reliability, and makes the system more cost efficient.

Furthermore, because device 800 has two amplification stages, each stage can have a smaller power gain than that of a single stage amplifier (e.g., amplifier 700 shown in FIG. 7) while still achieving the same output power. For example, as shown in Table 1 below, the first amplification stage of a two-stage amplification device may have an output power of about 1-3 mW, and the second amplification stage may have an output power of about 100 mW. Table 1 also shows that the maximum power gain of any one of the two amplification stages in device 800 is about 18-20 dB, compared to about 34 dB for the single-stage simplification device 700. An amplification stage having a smaller power gain facilitates reducing ASE and improves the signal-to-noise ratio of amplification device 800. It is understood that device 800 may be configured such that more or less of pump power can be delivered to the first power amplification stage (e.g., stage 814) and therefore, the output power of the first amplification stage and the second amplification stage may vary from those shown in Table 1.

TABLE 1

| | Output Power (mW) | Gain |
|---|---|---|
| Single Stage Amplifier | 100 | About 2500x or 34 dB |
| Double Stage Amplifier, | 1-3 | Less than or equal |
| first amplification stage | | to about 75x or 18 dB |
| Double Stage Amplifier, | 100 | Less than or equal |
| second amplification stage | | to 100x or 20 dB |

As described above, device 800 is configured such that optical power pump 826 is disposed at the backend of the amplification stages. The pump power is deliverable to the second power amplification stage (e.g., stage 816) from the backend of the second power amplification stage, thereby effectively performing backward pumping of the second power amplification stage. And a portion of the pump power is deliverable to the first power amplification stage (e.g., stage 814) from the front end of the first power amplification stage, thereby effectively performing forward pumping of the first power amplification stage. Therefore, this configuration is also referred to as a forward-pumping and backward-pumping configuration.

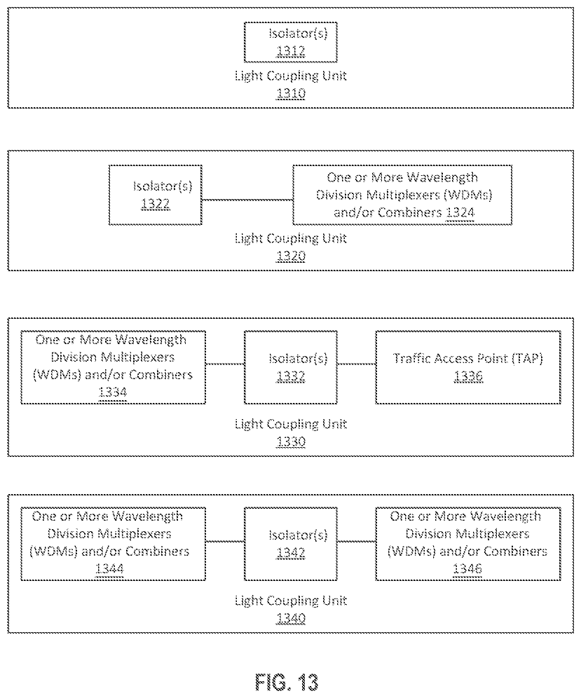

As also described above, multiple light coupling units 802, 804, and 806 are used in device 800. In one embodiment, each of light coupling units 802 and 804 includes an assembly of one or more optical isolators and one or more WDMs and/or combiners; and light coupling unit 806 includes an assembly of one or more WDMs and/or combiners, one or more optical isolators, and a TAP. FIG. 13 shows example light coupling units 1320, 1330, and 1340, one or more of which can be used to implement light coupling units 802, 804, and 806. As shown in FIG. 13, light coupling unit 1320 includes one or more optical isolators 1322 and one or more WDMs and/or combiners 1324. Light coupling unit 1330 includes one or more WDMs and/or combiners 1334, one or more isolators 1332, and a TAP 1336. As described above, an optical isolator can pass optical signals from its input to its output but not backward. Thus, the optical isolator prevents undesired feedback or reflection. In one configuration of device 800, each of light coupling units 802, 804, and 806 includes one or more optical isolators. As a result, the seed laser signal, the first amplified laser light generated by power amplification stage 814, and the second amplified laser light generated by power amplification stage 816 may only propagate forward, but not backward. It is understood that light coupling units shown in FIG. 13 are for illustrations only. The light coupling units can include more or fewer optical components as needed (e.g., more or fewer WDMs or combiners).

A WDM includes a multiplexer that multiplexes or combines multiple input optical signals and delivers the combined signals to a single optical fiber. The multiple input optical signals are carried by input laser light having different wavelengths. The input laser light having different wavelengths can be delivered by multiple input optical fibers. A WDM can also include a splitter to demultiplex or distribute the combined optical signals carried by a single optical fiber to multiple output optical signals. The multiple output optical signals are carried by output laser light having multiple wavelengths. These output laser light having multiple wavelengths can be carried by multiple output optical fibers. In some embodiments, an optical combiner can also be used in a light coupling unit instead of a WDM. An optical combiner is a passive device in which the laser light from multiple optical fibers can be combined and then distributed among one or more other optical fibers or photoreceivers.

In one configuration of device 800, for example, one or more light coupling units 802, 804, and 806 can include one or more WDMs and/or one or more optical combiners. A WDM or optical combiner in light coupling unit 802 can combine the seed laser light and the portion of pump laser light delivered by fiber-based delivering medium 822. The combined light is delivered to power amplification stage 814, where the portion of the pump laser light is used to amplify the seed laser light. A WDM and/or combiner in light coupling unit 804 can deliver the first amplified laser light generated by power amplification stage 814 to power amplification stage 816. One or more WDMs and/or combiners can operate as an optical splitter in light coupling unit 804, which can decouple a portion of the pump laser light that is unused by power amplification stage 816 from signal laser light (e.g., decoupling by wavelength splitting). After decoupling, the WDM(s) and/or combiner(s) can deliver the portion of the pump laser light that is unused by power amplification stage 816 to fiber-based delivery medium 822, thereby providing a portion of the pump power generated by optical power pump 826 to power amplification stage 814. A WDM and/or combiner in light coupling unit 802 can combine the portion of the pump laser light that is delivered by fiber-based delivery medium 822 and seed laser 812. The combined light is provided to power amplification stage 814. In one embodiment, light coupling unit 804 can be implemented by light coupling unit 1340, which has multiple WDM and/or combiners. In this manner, the pump power generated by a single optical power pump is provided to two amplification stages.

In one configuration of device 800, light coupling unit 806 can also include one or more WDMs and/or one or more optical combiners. A WDM and/or combiner in light coupling unit 806 can deliver the pump laser light generated by optical power pump 826 to power amplification stage 816. A WDM and/or combiner in light coupling unit 806 can deliver the second amplified laser light generated by power amplification stage 816 to other optical components (e.g., a TAP in light coupling unit 806). For instance, by using a WDM or combiner in light coupling unit 806, the second amplified laser light can be delivered to an optical isolator (e.g., optical isolator 1332 shown in FIG. 13). The optical isolator passes the second amplified laser light forward to another optical component, but not backward. In one example, the isolator passes the second amplified laser light to a TAP in light coupling unit 806 (e.g., TAP 1336 shown in FIG. 13). A TAP is an access point that provides real-time monitoring of the optical signals.

The above-described light coupling units 802, 804, and 806 can each be an assembly of one or more optical components (e.g., isolator, WDM, combiner, and/or TAP). By assembling multiple optical components within a same light coupling unit, it reduces the complexity or cumbersomeness associated with assembly, maintenance, or repair of the light coupling units. This may be highly desirable if device 800 is used in a vehicle. Typically, repairing or replacing an individual optical component may be time consuming and costly due to the requirements of optical alignment, tuning, calibration, etc. By assembling multiple optical components in a single light coupling unit, the repair or maintenance can be performed by simply replacing the entire light coupling unit. For example, if a LiDAR system comprising device 800 is mounted in a vehicle and needs to be repaired, one or more of the light coupling units 802, 804, and 806 can simply be replaced with new units during a regular scheduled vehicle maintenance visit, thereby making the system maintenance more efficient and cost effective.

Referencing still to FIG. 8, in some embodiments, device 800 includes photodetector 828, which receives at least a portion of the second amplified laser light via optical path 829 (e.g., an optical fiber). Photodetector 828 can provide measurements of the output power of the second amplified laser light generated by power amplification stage 816. Photodetector 828 can be enabled or disabled depending on if measurement of the output power is needed. The second amplified laser light passes through light coupling unit 806 and is then delivered to other optical components 820 (e.g., lens, mirrors, etc.) via optical path 818. Optical path 818 includes optical fiber and/or free-space optical components. Other optical components 820 may include other components (e.g., polygon mirror, collimation lens, or the like) used in, for example, a LiDAR system.

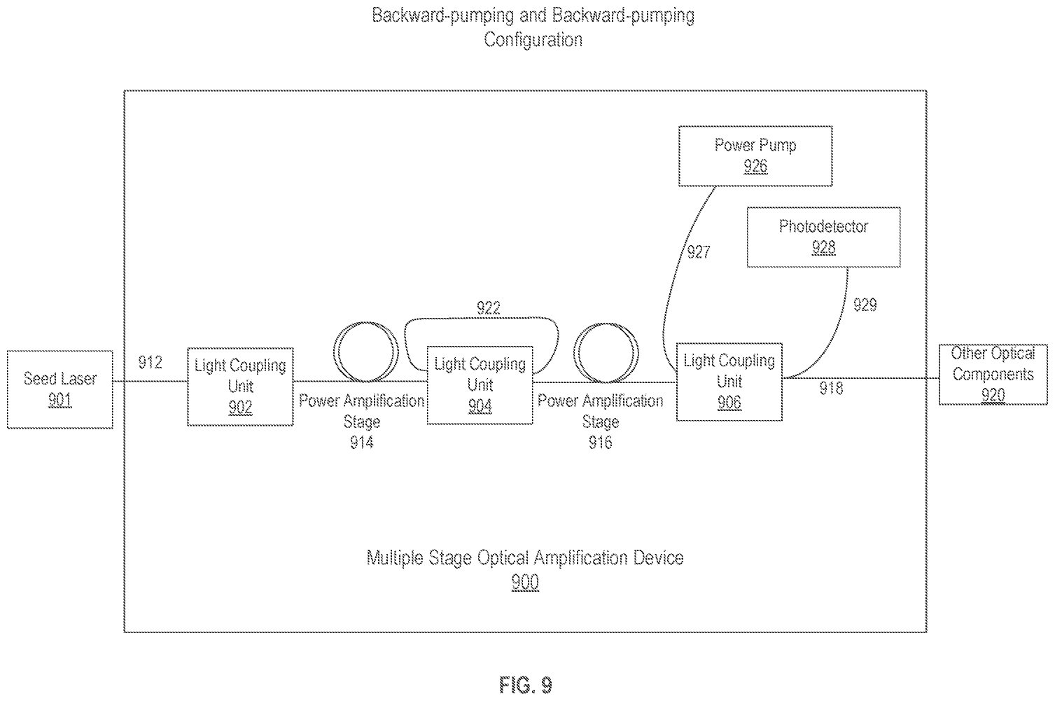

FIG. 9 illustrates a multiple stage optical amplification device 900 having a backward-pumping and backward-pumping configuration according to one embodiment. Multiple stage optical amplification device 900 comprises light coupling units 902, 904, and 906, power amplification stages 914 and 916, a single optical power pump 926, photodetector 928, a fiber-based delivering medium 922, and optical paths 912, 918, 927, and 929. Similar to device 800, device 900 is thus also a two stage amplification device having a single optical power pump. In one embodiment, light coupling unit 902 is optically coupled to seed laser 901 via optical path 912. Seed laser 901 and optical path 912 are similar to seed laser 801 and optical path 812 described above, respectively, and are thus not repeatedly described.

In addition to being coupled to seed laser 901, light coupling unit 902 is optically coupled to a first end (e.g., the front end) of power amplification stage 914 as shown in FIG. 9. Thus, light coupling unit 902 passes the seed laser light to power amplification stage 914. The second end (e.g., the backend) of power amplification stage 914 is coupled to light coupling unit 904. Device 900 further includes a fiber-based delivering medium 922. The first end of fiber-based delivering medium 922 is optically coupled to the second end (e.g., the backend) of the first power amplification stage 914 via light coupling unit 904. The second end of fiber-based delivering medium 922 is optically coupled to a first end (e.g., the front end) of the second power amplification stage 916 also via light coupling unit 904. Light coupling unit 904 is optically coupled to a first end (e.g., the front end) of power amplification stage 916. The second end (e.g., the backend) of power amplification stage 916 is optically coupled to an optical power pump 926 via another light coupling unit 906.

In device 900, power amplification stages 914 and 916 each comprises a fiber-based amplification medium such as a rare earth doped medium (e.g., doped with at least one of Yb, Er, Tm, or Nd). The amplification media included in power amplification stages 914 and 916 may be the same or different. For example, each of amplification stages 914 and 916 may comprise a 1550 nm single mode Er-doped fiber-based amplification medium. Optical power pump 926 can provide pump laser light using, for example, one or more laser diodes. In one example, optical power pump 926 is a 400 mW single model pump producing pump laser light having a 980 nm wavelength. It is understood that power amplification stages 914 and 916 can include any type of doped media to produce output light having any desired wavelengths (e.g., 1030 nm, 1064 nm, 1530 nm, 1550 nm, 2 μm, or the like). In addition, optical power pump 926 can also be configured to provide pump laser light having any desired wavelengths (e.g., 915 nm, 940 nm, 980 nm, 1530 nm, or the like). Further, the fiber-based amplification medium can comprise single mode fibers, large mode area (LMA) fibers, double-clad fibers, or the like. The pump laser light may have a wavelength that is different from, or the same as, the seed laser light provided by seed laser 901.

Unlike device 700, in which optical power pump 726 is disposed at the front end of the power amplifier, optical power pump 926 of device 900 is disposed at the backend of power amplification stage 916. In this configuration shown in FIG. 9, optical power pump 926 can provide pump power to both power amplification stages 914 and 916. As shown in FIG. 9, optical power pump 926 is optically coupled to the backend of power amplification stage 916 via light coupling unit 906. Optical power pump 926 generates pump laser light to provide pump power. The pump power provided by optical power pump 926 is delivered to light coupling unit 906 via optical path 927 (e.g., an optical fiber). Light coupling unit 906 delivers the pump laser light to power amplification stage 916 to provide pump power (e.g., using a WDM or combiner in light coupling unit 906). A portion of the pump power is used in power amplification stage 916 for amplification and another portion of the pump power is delivered to light coupling unit 904. Similar to those described above, light coupling unit 904 can include one or more WDMs and/or combiners. A WDM and/or combiner in light coupling unit 904 decouples the portion of the pump power that is unused by power amplification stage 916. Light coupling unit 904 then provides the received portion of the pump power that is unused by power amplification stage 916 to the backend of power amplification stage 914 using fiber-based delivering medium 922. As described above, light coupling unit 902 passes the seed laser light generated by seed laser 901 to power amplification stage 914. Because light coupling unit 904 is optically coupled to the backend of power amplification stage 914, the portion of the pump power delivered by fiber-based delivering medium 922 can then be delivered to power amplification stage 914. This portion of the pump power can thus be used to amplify the seed laser light that is also delivered to power amplification stage 914. Amplification can be obtained by stimulated emission of photons from dopant ions in the doped optical fiber used in power amplification stage 914. In particular, the portion of the pump power delivered by fiber-based delivering medium 922 excites ions into an upper energy level from where they can decay via stimulated emission of a photon at the desired signal wavelength back to a lower energy level. As a result, power amplification stage 914 is a first amplification stage that amplifies the seed laser light and generates the first amplified laser light.

Next, light coupling unit 904 delivers (e.g., using a WDM and/or combiner) the first amplified laser light to power amplification stage 916, which uses a portion of the pump power provided by optical power pump 926 via light coupling unit 906. The first amplified laser light is thus further amplified in a similar manner. In particular, a portion of the pump power provided by optical power pump 926 is absorbed by the doped optical fiber of power amplification stage 916 to excite dopant ions. The decay of the excited ions from an upper energy level to a lower energy level generates a second amplified laser light having the desired signal wavelength (e.g., 1550 nm).

In one example, about 50-80% (e.g., 70%) of the pump power provided by the optical power pump 926 is used for the second stage amplification by power amplification stage 916. The remaining about 10-50% (e.g., 30%) of the pump power is delivered to the power amplification stage 914 and is used for the first stage amplification. Thus, the configuration of device 900 shown in FIG. 9 can use a single optical power pump to provide two stage amplifications, making more efficient use of the pump power and reducing energy waste. Device 900 also does not require to use a laser light splitter for splitting the pump laser light to be used in two amplification stages, thereby reducing the number of required optical components. Device 900 also does not require other additional optical components (e.g., pump power strippers), therefore enhancing the hardware integration. The reduced number of optical components enhances the system robustness and reliability, and makes the system more cost efficient.

In one example, the output power of the output signal from device 900 is about 20-60% higher than a single stage amplifier such as the one shown in FIG. 7. A higher output power enables the light signal to travel to a far-distance object. As a result, a LiDAR device using such a light signal can detect an object that is located far away from the device (e.g., more than about 100-250 meters).

Furthermore, because device 900 has two amplification stages, each stage can have a smaller power gain than that of a single stage amplifier (e.g., amplifier 700 shown in FIG. 7) while still achieving the same output power. The output power and power gain for each amplification stage of device 900 can be similar to, or different from, those of device 800, as shown in Table 1 above. An amplification stage having a smaller power gain facilitates reducing ASE and improving the signal-to-noise ratio of the amplification device 900. It is understood that device 900 may be configured such that more or less of the pump power is delivered to the first power amplification stage (e.g., stage 914) and therefore, the output power of the first amplification stage and the second amplification stage may vary.

As described above, device 900 is configured such that the optical power pump 926 is disposed at the backend of the amplification stages. The pump power is deliverable to the second power amplification stage (e.g., stage 916) from the backend of the second power amplification stage, thereby effectively performing backward pumping of the second power amplification stage. And a portion of the pump power is deliverable to the first power amplification stage (e.g., stage 914) from the backend of the first power amplification stage, thereby also effectively performing backward pumping of the first power amplification stage. Therefore, this configuration is also referred to as a backward-pumping and backward-pumping configuration.

As also described above, multiple light coupling units 902, 904, and 906 are used in device 900. In one embodiment, light coupling unit 902 includes an optical isolator. Light coupling unit 904 includes an assembly of one or more optical isolators and multiple WDMs and/or combiners. Light coupling unit 906 includes an assembly of one or more WDMs and/or combiners, one or more optical isolators, and a TAP. FIG. 13 shows example light coupling units 1310, 1340, and 1330, one or more of which can be used to implement light coupling units 902, 904, and 906. In one embodiment, light coupling unit 1310 includes one or more optical isolators 1312. As shown in FIG. 13, light coupling unit 1340 includes one or more optical isolators 1342 and multiple WDMs and/or combiners 1344 and 1346. Light coupling unit 1330 includes one or more WDMs and/or combiners 1334, one or more isolators 1332, and a TAP 1336. As described above, an optical isolator can pass optical signals from its input to its output but not backward. Thus, the optical isolator prevents undesired feedback or reflection. In one configuration of device 900, each of light coupling units 902, 904, and 906 includes an optical isolator. As a result, the seed laser signal, the first amplified laser light generated by power amplification stage 914, and the second amplified laser light generated by power amplification stage 916 can only propagate forward, but not backward. It is understood that light coupling units shown in FIG. 13 are for illustrations only. The light coupling units can include more or fewer optical components as needed (e.g., more or fewer WDMs or combiners).

In one configuration of device 900, light coupling units 904 and 906 can each include one or more WDMs or one or more optical combiners. For example, light coupling unit 904 includes a first WDM or combiner coupled to power amplification stage 914 and a second WDM or combiner coupled to power amplification stage 916. Light coupling unit 904 can also include an isolator such that signals propagate forward, not backward. In one embodiment, both the first and second WDMs are also coupled to fiber-based delivering medium 922. Thus, the first WDM of light coupling unit 904 can deliver the portion of pump laser light delivered by fiber-based delivering medium 922 to power amplification stage 914. In some embodiments, one of the one or more WDMs and/or combiners in light coupling unit 904 is used to pass the first amplified laser light generated by power amplification stage 914 to power amplification stage 916 (e.g., via the isolator and the second WDM) for further amplification. One of the one or more WDMs and/or combiners in light coupling unit 904 decouples a portion of the pump laser light that is unused by power amplification stage 916 from signal laser light in power amplification stage 916 (e.g., by using wavelength splitting). After decoupling, the WDM and/or combiner delivers the portion of the pump laser light that is unused by power amplification stage 916 into fiber-based delivery medium 922, thereby providing a portion of the pump power generated by optical power pump 926 to power amplification stage 914 (e.g., via the first WDM or combiner in light coupling unit 904). In some embodiments, one of the one or more WDMs and/or combiners of light coupling unit 904 facilitates delivering the first amplified laser light generated by power amplification stage 914 to power amplification stage 916 for further amplification. In this manner, the pump power generated by single optical power pump 926 is provided to two amplification stages 914 and 916.

In one configuration of device 900, light coupling unit 906 can include one or more WDMs and/or one or more optical combiner, an optical isolator, and a TAP. Light coupling unit 906 can be configured to be the same or similar to light coupling unit 806 and is therefore not repeatedly described. Similar to the above-described light coupling units 802, 804, and 806, light coupling units 902, 904, and 906 can each be an assembly of one or more optical components (e.g., isolator(s), WDM(s), combiner(s), and/or TAP(s)). By assembling multiple optical components within a same light coupling unit, it reduces the complexity or cumbersomeness associated with assembly, maintenance, or repair of the light coupling units.

Referencing still to FIG. 9, in some embodiments, device 900 includes photodetector 928, which receives at least a portion of the second amplified laser light via optical path 929 (e.g., an optical fiber). Photodetector 928 can provide measurements of the output power of the second amplified laser light. Photodetector 928 can be enabled or disabled depending on if measurement of the output power is needed. The second amplified laser light passes through light coupling unit 906 and is then delivered to other optical components 920 (e.g., lens, mirrors, etc.) via optical path 918. Optical path 918 includes an optical fiber and/or free-space optical components. The other optical components 920 may include other components (e.g., polygon mirror, collimation lens, or the like) used in, for example, a LiDAR system.

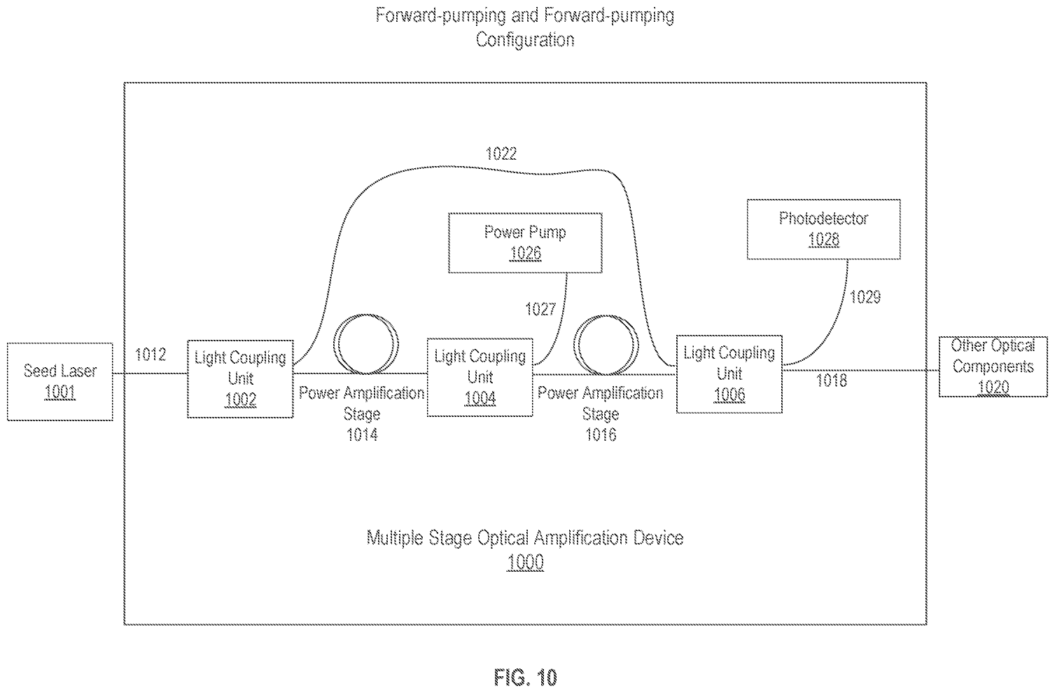

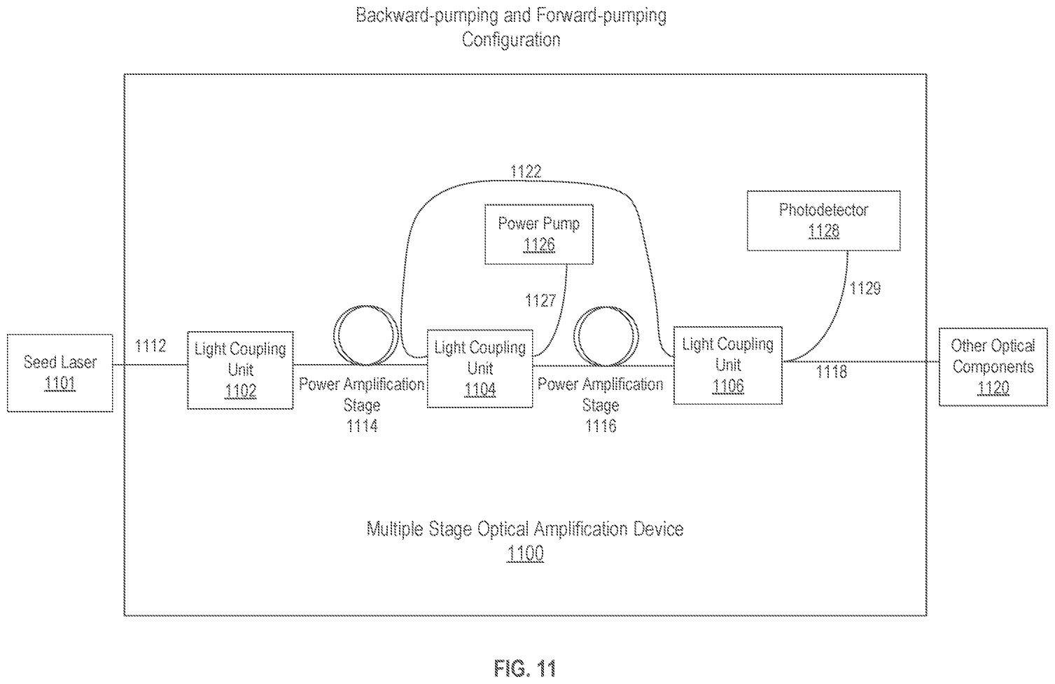

FIG. 10 illustrates a multiple stage optical amplification device 1000 having a forward-pumping and forward-pumping configuration according to one embodiment. Multiple stage optical amplification device 1000 comprises light coupling units 1002, 1004, and 1006, power amplification stages 1014 and 1016, a single optical power pump 1026, a photodetector 1028, a fiber-based delivering medium 1022, and optical paths 1012, 1018, 1027, and 1029. Similar to device 800, device 1000 is thus also a two stage amplification device having a single optical power pump. In one embodiment, light coupling unit 1002 is optically coupled to seed laser 1001 via optical path 1012. Seed laser 1001 and optical path 1012 are similar to seed laser 801 and optical path 812 described above, respectively, and are thus not repeatedly described.

In addition to being coupled to seed laser 1001, light coupling unit 1002 is optically coupled to a first end (e.g., the front end) of power amplification stage 1014 and a first end of a fiber-based delivering medium 1022, as shown in FIG. 10. The first end of fiber-based delivering medium 1022 is optically coupled to the front end of the first power amplification stage 1014 via light coupling unit 1002. Device 1000 further comprises light coupling unit 1004. Light coupling unit 1004 is optically coupled to a second end (e.g., the backend) of power amplification stage 1014. Light coupling unit 1004 is further optically coupled to a first end (e.g., the front end) of a second power amplification stage 1016 and an optical power pump 1026. The second end (e.g., the backend) of power amplification stage 1016 is optically coupled to the second end of fiber-based delivering medium 1022 via light coupling unit 1006.

In device 1000, power amplification stages 1014 and 1016 each comprises a fiber-based amplification medium such as a rare earth doped medium (e.g., doped with at least one of Yb, Er, Tm, or Nd). The amplification media included in power amplification stages 1014 and 1016 may be the same or different. For example, each of amplification stages 1014 and 1016 may comprise a 1550 nm single mode Er-doped fiber-based amplification medium. Optical power pump 1026 can provide pump laser light using, for example, one or more laser diodes. In one example, optical power pump 1026 is a 400 mW single model pump producing pump laser light having a 980 nm wavelength. It is understood that power amplification stages 1014 and 1016 can include any type of doped media to produce output light having any desired wavelengths (e.g., 1030 nm, 1064 nm, 1530 nm, 1550 nm, 2 μm, or the like). In addition, optical power pump 1026 can also be configured to provide pump laser light having any desired wavelengths (e.g., 915 nm, 940 nm, 980 nm, 1530 nm, or the like). Further, the fiber-based amplification medium can comprise single mode fibers, large mode area (LMA) fibers, double-clad fibers, or the like. The pump laser light may have a wavelength that is different from, or the same as, the seed laser light provided by seed laser 1001.

In this configuration shown in FIG. 10, optical power pump 1026 is disposed at the front end of the second power amplification stage (e.g., stage 1016). Optical power pump 1026 can provide pump power to both power amplification stages 1014 and 1016. As shown in FIG. 10, optical power pump 1026 is optically coupled to the front end of power amplification stage 1016 via light coupling unit 1004 (e.g., using one or more WDMs or combiners). Optical power pump 1026 generates pump laser light to provide pump power. The pump laser light provided by optical power pump 1026 is delivered to light coupling unit 1004 via optical path 1027 (e.g., an optical fiber). Light coupling unit 1006 delivers the pump laser light to power amplification stage 1016 to provide pump power. A portion of the pump power is used in power amplification stage 1016 for amplification and another portion of the pump power is delivered to light coupling unit 1002 using fiber-based delivering medium 1022 via light coupling unit 1006 (e.g., using one or more WDMs and/or combiners). Light coupling unit 1002 combines seed laser light generated by seed laser 1001 with the portion of the pump power (in the form of pump laser light) delivered by fiber-based delivering medium 1022. Because light coupling unit 1002 is optically coupled to the front end of power amplification stage 1014, the portion of the pump power delivered by fiber-based delivering medium 1022 can be used to amplify the seed laser light by power amplification stage 1014. Amplification can be obtained by stimulated emission of photons from dopant ions in the doped optical fiber used in power amplification stage 1014. In particular, the portion of the pump power delivered by fiber-based delivering medium 1022 excites ions into an upper energy level from where they can decay via stimulated emission of a photon at the desired signal wavelength back to a lower energy level. As a result, power amplification stage 1014 is a first amplification stage that amplifies the seed laser light and generates the first amplified laser light.

Next, light coupling unit 1004 receives both the first amplified laser light and the pump laser light generated by optical power pump 1026. Light coupling unit 1004 combines (e.g., using one or more WDMs or combiners) the first amplified laser light and the pump laser light generated by optical power pump 1026 and delivers the combined light to power amplification stage 1016, which uses a portion of the pump power provided by optical power pump 1026 to further amplify the first amplified laser light. The first amplified laser light is further amplified in a similar manner as in the power amplification stage 1014. In particular, a portion of the pump power provided by optical power pump 1026 is absorbed by the doped optical fiber of power amplification stage 1016 to excite dopant ions. The decay of the excited ions from an upper energy level to a lower energy level generates a second amplified laser light having the desired signal wavelength (e.g., 1550 nm).

In one example, about 50-90% (e.g., 70%) of the pump power provided by the optical power pump 1026 is used for the second stage amplification by power amplification stage 1016. The remaining about 10-50% (e.g., 30%) of the pump power is delivered to the power amplification stage 1014 and is used for the first stage amplification. Thus, the configuration of device 1000 shown in FIG. 10 can use a single optical power pump to provide two stage amplifications, making more efficient use of the pump power and reducing energy waste. Device 1000 also does not require to use a laser light splitter for splitting the pump laser light to be used in two amplification stages, thereby reducing the number of required optical components. Device 1000 also does not require other additional optical components (e.g., pump power strippers), therefore enhancing the hardware integration. The reduced number of optical components enhances the system robustness and reliability, and makes the system more cost efficient.

In one example, the output power of the output signal from device 1000 is about 20-60% higher than a single stage amplifier such as the one shown in FIG. 7. A higher output power enables the light signal to travel to a far-distance object. As a result, a LiDAR device using the such a light signal can detect object that is located far away from the device (e.g., more than about 100-250 meters).

Furthermore, because device 1000 has two amplification stages, each stage can have a smaller power gain than that of a single stage amplifier (e.g., amplifier 700 shown in FIG. 7) while still obtaining the same output power. The output power and power gain for each amplification stage of device 1000 can be similar to, or different from, those of device 800, as shown in Table 1 above. An amplification stage having a smaller power gain facilitates reducing ASE and improving the signal-to-noise ratio of the amplification device 1000. It is understood that device 1000 may be configured such that more or less pump power can be delivered to the first power amplification stage (e.g., stage 1014) and therefore, the output power of the first amplification stage and the second amplification stage may vary.

As described above, device 1000 is configured such that the optical power pump 1026 is disposed at the front end of the second amplification stage. The pump power is deliverable to the second power amplification stage (e.g., stage 1016) from its front end, thereby effectively performing a forward pumping of the second power amplification stage. And a portion of the pump power is deliverable to the first power amplification stage (e.g., stage 1014) from its front end, thereby also effectively performing a forward pumping of the first power amplification stage. Therefore, this configuration is also referred to as a forward-pumping and forward-pumping configuration.

As also described above, multiple light coupling units 1002, 1004, and 1006 are used in device 1000. In one embodiment, each of light coupling units 1002 and 1004 includes an assembly of one or more optical isolators and one or more WDMs and/or one or more combiners; and light coupling unit 1006 includes an assembly of one or more WDMs and/or one or more combiners, one or more optical isolators, and a TAP. FIG. 13 shows example light coupling units 1320, 1330, and 1340, one or more of which can be used to implement light coupling units 1002, 1004, and 1006. As shown in FIG. 13, light coupling unit 1320 includes one or more optical isolators 1322 and one or more WDMs and/or combiners 1324. Light coupling unit 1330 includes one or more WDMs and/or combiners 1334, one or more isolators 1332, and a TAP 1336. As described above, an optical isolator can pass optical signals from its input to its output but not backward. Thus, the optical isolator prevents undesired feedback or reflection. In one configuration of device 1000, each of light coupling units 1002, 1004, and 1006 includes an optical isolator. As a result, the seed laser signal, the first amplified laser light generated by power amplification stage 1014, and the second amplified laser light generated by power amplification stage 1016 can only propagate forward, but not backward. It is understood that light coupling units shown in FIG. 13 are for illustrations only. The light coupling units can include more or fewer optical components as needed (e.g., more or fewer WDMs or combiners).

In one configuration of device 1000, for example, one or more light coupling units 1002, 1004, and 1006 can include one or more WDMs and/or one or more optical combiners. A WDM or optical combiner of light coupling unit 1002 can combine the seed laser light and the portion of pump laser light delivered by fiber-based delivering medium 1022. The combined light is delivered to power amplification stage 1014 for amplification of the seed laser light. A WDM or optical combiner of light coupling unit 1004 receives the first amplified laser light and pump laser light generated by optical power pump 1026. It combines the first amplified laser light with the pump laser light generated by optical power pump 1026 and delivers the combined light to power amplification stage 1016, where the pump laser light is used to amplify the first amplified laser light to obtain the second amplified laser light. In this manner, the pump power generated by a single optical power pump is provided to two amplification stages.

In one configuration of device 1000, light coupling unit 1006 can include one or more WDMs and/or one or more optical combiners. A WDM and/or combiner in light coupling unit 1006 can deliver a portion of the pump laser light unused by power amplification stage 1016 to fiber-based delivering medium 1022. In one example, a WDM and/or combiner of light coupling unit 1006 can deliver the second amplified laser light generated by power amplification stage 1016 to other optical components. For instance, by using the WDM, the second amplified laser light can be delivered to an isolator (e.g., isolator 1332 shown in FIG. 13). The isolator passes the second amplified laser light forward to another optical component, but not backward. In one example, the isolator passes the second amplified laser light to a TAP (e.g., TAP 1336 shown in FIG. 13). A TAP is an access point that provides real-time monitoring of the optical signals.

The above-described light coupling units 1002, 1004, and 1006 can each be an assembly of one or more optical components (e.g., isolator(s), WDM(s), combiner(s), and/or TAP(s)). By assembling multiple optical components within a same light coupling unit, it reduces the complexity or cumbersomeness associated with assembly, maintenance, or repair of the light coupling units. This may be highly desirable if device 1000 is used in a vehicle. Typically, repairing or replacing an individual optical component may be time consuming and costly due to the requirements of optical alignment, tuning, calibration, etc. By assembling multiple optical components in a single light coupling unit, the repair or replacement can be performed by simply replacing the entire light coupling unit. For example, if a LiDAR system comprising device 1000 is mounted in a vehicle and needs to be repaired, one or more of the light coupling units 1002, 1004, and 1006 can simply be replaced with new units during a regular scheduled vehicle maintenance visit, thereby making the system maintenance more efficient and cost effective.

Referencing still to FIG. 10, in some embodiments, device 1000 includes photodetector 1028, which receives at least a portion of the second amplified laser light via optical fiber 1029. Photodetector 1028 can provide measurements of the output power of the second amplified laser light. Photodetector 1028 can be enabled or disabled depending on if measurement of the output power is needed. The second amplified laser light passes through light coupling unit 1006 and is then delivered to other optical components 1020 (e.g., lens, mirrors, etc.) via optical path 1018. Optical path 1018 includes optical fiber or free-space optical components. The other optical components 1020 may include other components (e.g., polygon mirror, collimation lens, or the like) used in, for example, a LiDAR system.

FIG. 11 illustrates a multiple stage optical amplification device 1100 having a backward-pumping and forward-pumping configuration according to one embodiment. Multiple stage optical amplification device 1100 comprises light coupling units 1102, 1104, and 1106, power amplification stages 1114 and 1116, a single optical power pump 1126, a photodetector 1128, a fiber-based delivering medium 1122, and optical paths 1112, 1118, 1127, and 1129. Similar to device 800, device 1100 is thus also a two stage amplification device having a single optical power pump. In one embodiment, light coupling unit 1102 is optically coupled to seed laser 1101 via optical path 1112. Seed laser 1101 and optical path 1112 are similar to seed laser 801 and optical path 812, respectively, as described above, and are thus not repeatedly described.

In addition to being coupled to seed laser 1101, light coupling unit 1102 is optically coupled to a first end (e.g., the front end) of power amplification stage 1114 as shown in FIG. 11. Thus, light coupling unit 1102 passes the seed laser light to power amplification stage 1114. The second end (e.g., the backend) of power amplification stage 1114 is optically coupled to light coupling unit 1104. Device 1100 further includes a fiber-based delivering medium 1122. Light coupling unit 1104 is also optically coupled to a first end of fiber-based delivering medium 1122. Light coupling unit 1104 is further optically coupled to a first end (e.g., the front end) of a second power amplification stage 1116 and an optical power pump 1126. The second end (e.g., the backend) of power amplification stage 1116 is optically coupled to the second end of fiber-based delivering medium 1122 via light coupling unit 1106.

In device 1100, power amplification stages 1114 and 1116 each comprises a fiber-based amplification medium such as a rare earth doped medium (e.g., doped with at least one of Yb, Er, Tm, or Nd). The amplification media included in power amplification stages 1114 and 1116 may be the same or different. For example, each of amplification stages 1114 and 1116 may comprise a 1550 nm single mode Er-doped fiber-based amplification medium. Optical power pump 1126 can provide pump laser light using, for example, one or more laser diodes. In one example, optical power pump 1126 is a 400 mW single model pump producing pump laser light having a 980 nm wavelength. It is understood that power amplification stages 1114 and 1116 can include any type of doped media to produce output light having any desired wavelengths (e.g., 1030 nm, 1064 nm, 1530 nm, 1550 nm, 2 μm, or the like). In addition, the optical power pump 1126 can also be configured to provide pump laser light having any desired wavelengths (e.g., 915 nm, 940 nm, 980 nm, 1530 nm, or the like). Further, the fiber-based amplification medium can comprise single mode fibers, large mode area (LMA) fibers, double-clad fibers, or the like. The pump laser light may have a wavelength that is different from, or the same as, the seed laser provided by seed laser 1101.

In this configuration shown in FIG. 11, optical power pump 1126 is disposed at the front end of the second power amplification stage 1116. Optical power pump 1126 can provide pump power to both power amplification stages 1114 and 1116. As shown in FIG. 11, optical power pump 1126 is optically coupled to the front end of power amplification stage 1116 via light coupling unit 1104 (e.g., using one or more WDMs and/or combiners). Optical power pump 1126 generates pump laser light to provide pump power. The pump laser light provided by optical power pump 1126 is delivered to light coupling unit 1104 via optical path 1127 (e.g., an optical fiber). Light coupling unit 1106 delivers the pump laser light to power amplification stage 1116 to provide pump power. A portion of the pump power is used in power amplification stage 1116 for amplification and another portion of the pump power is delivered to power amplification stage 1114 using light coupling unit 1106, fiber-based delivering medium 1122, and light coupling unit 1104.

Light coupling unit 1104 then provides the portion of the pump power to the backend of power amplification stage 1114. As described above, light coupling unit 1102 delivers the seed laser light generated by seed laser 1101 to power amplification stage 1114. Because light coupling unit 1104 is optically coupled to the backend of power amplification stage 1114, the portion of the pump power delivered by fiber-based delivering medium 1122 can then be delivered to power amplification stage 1114. This portion of the pump power can thus be used to amplify the seed laser light that is also delivered to power amplification stage 1114. Amplification can be obtained by stimulated emission of photons from dopant ions in the doped optical fiber used in power amplification stage 1114. In particular, the portion of the pump power delivered by fiber-based delivering medium 1122 excites ions into an upper energy level from where they can decay via stimulated emission of a photon at the desired signal wavelength back to a lower energy level. As a result, power amplification stage 1114 is a first amplification stage that amplifies the seed laser light to generate the first amplified laser light.

Next, light coupling unit 1104 delivers the first amplified laser light to power amplification stage 1116, which uses the pump power provided by optical power pump 1126 via light coupling unit 1104. The first amplified laser light is thus further amplified in a similar manner. In particular, a portion of the pump power provided by optical power pump 1126 is absorbed by the doped optical fiber of power amplification stage 1116 to excite dopant ions. The decay of the excited ions from an upper energy level to a lower energy level generates a second amplified laser light having the desired signal wavelength (e.g., 1550 nm).

In one example, about 50-90% (e.g., 70%) of the pump power provided by the optical power pump 1126 is used for the second stage amplification by power amplification stage 1116. The remaining about 10-50% (e.g., 30%) of the pump power is delivered to the power amplification stage 1114 and is used for the first stage amplification. Thus, the configuration of device 1100 shown in FIG. 11 can use a single optical power pump to provide two stage amplifications, making more efficient use of the pump power and reducing energy waste. Device 1100 also does not require to use a laser light splitter for splitting the pump laser light to be used in two amplification stages, thereby reducing the number of required optical components. Device 1100 also does not require other additional optical components (e.g., pump power strippers), therefore enhancing the hardware integration. The reduced number of optical components enhances the system robustness and reliability, and makes the system more cost efficient.

In one example, the output power of the output signal from device 1100 is about 20-60% higher than a single stage amplifier such as the one shown in FIG. 7. A higher output power enables the light signal to travel to a far-distance object. As a result, a LiDAR device using such a light signal can detect object that is located far away from the device (e.g., more than about 100-250 meters).

Furthermore, because device 1100 has two amplification stages, each stage can have a smaller power gain than that of a single stage amplifier (e.g., amplifier 700 shown in FIG. 7) while still obtaining the same output power. The output power and power gain for each amplification stage of device 1100 can be similar to, or different from, those of device 800, as shown in Table 1 above. An amplification stage having a smaller power gain facilitates reducing ASE and improving the signal-to-noise ratio of the amplification device 1100. It is understood that device 1100 may be configured such that more or less pump power can be delivered to the first power amplification stage (e.g., stage 1114) and therefore, the output power of the first amplification stage and the second amplification stage may vary.

As described above, device 1100 is configured such that optical power pump 1126 is disposed at the front end of the second amplification stage. The pump power is deliverable to the second power amplification stage (e.g., stage 1116) from its front end, thereby effectively performing forward pumping of the second power amplification stage. And a portion of the pump power is deliverable to the first power amplification stage (e.g., stage 1114) from its backend, thereby effectively performing backward pumping of the first power amplification stage. Therefore, this configuration is also referred to as a backward-pumping and forward-pumping configuration.

As also described above, multiple light coupling units 1102, 1104, and 1106 are used in device 1100. In one embodiment, light coupling unit 1102 includes an optical isolator. Light coupling unit 1104 includes an assembly of one or more optical isolators and multiple WDMs and/or combiners. Light coupling unit 1106 includes an assembly of one or more WDMs and/or combiners, one or more optical isolators, and a TAP. FIG. 13 shows example light coupling units 1310, 1340, and 1330, one or more of which can be used to implement light coupling units 1102, 1104, and 1106. In one embodiment as shown in FIG. 13, light coupling unit 1310 includes one or more optical isolators 1312. Light coupling unit 1340 includes one or more optical isolators 1342 and multiple WDMs and/or combiners 1344 and 1346. Light coupling unit 1330 includes one or more WDMs and/or combiners 1334, one or more isolators 1332, and a TAP 1336. As described above, an optical isolator can pass optical signals from its input to its output but not backward. Thus, the optical isolator prevents undesired feedback or reflection. In one configuration of device 1100, each of light coupling units 1102, 1104, and 1106 includes an optical isolator. As a result, the seed laser signal, the first amplified laser light generated by power amplification stage 1114, and the second amplified laser light generated by power amplification stage 1116 can only propagate forward, but not backward. It is understood that light coupling units shown in FIG. 13 are for illustrations only. The light coupling units can include more or fewer optical components as needed (e.g., more or fewer WDMs or combiners).

In one configuration of device 1100, light coupling units 1104 and 1106 can include one or more WDMs or one or more optical combiners. For example, light coupling unit 1104 includes one or more first WDMs and/or combiners coupled to power amplification stage 1114 and one or more second WDMs and/or combiners coupled to power amplification stage 1116. Light coupling unit 1104 can further include one or more isolators. A WDM and/or combiner is coupled to fiber-based delivering medium 1122. A WDM and/or combiner is coupled to optical power pump 1126. Thus, a WDM and/or combiner of light coupling unit 1104 can deliver a portion of pump laser light delivered by fiber-based delivering medium 1122 to power amplification stage 1114. The portion of the pump laser light provides pump power to power amplification stage 1114 for amplification of the seed laser light. A WDM and/or combiner in light coupling unit 1104 can deliver the first amplified laser light generated by power amplification stage 1114 to power amplification stage 1116 (e.g., via the isolator and/or another WDM) for further amplification. AWDM and/or combiner in light coupling unit 1104 receives the first amplified laser light and pump laser light generated by optical power pump 1126. It combines the first amplified laser light with the pump laser light generated by optical power pump 1126 and delivers the combined light to power amplification stage 1116 for amplification of the first amplified laser light. In this manner, the pump power generated by a single optical power pump is provided to two amplification stages.

In one configuration of device 1100, light coupling unit 1106 can include an assembly of one or more WDMs and/or one or more optical combiners, one or more optical isolators, and a TAP. Light coupling unit 1106 can be configured to be the same or similar to light coupling unit 806 and is therefore not repeatedly described. Similar to the above-described light coupling units 802, 804, and 806, light coupling units 1102, 1104, and 1106 can also be assemblies of one or more optical components (e.g., isolator(s), WDM(s), combiner(s), and/or TAP(s)). By assembling multiple optical components within a same light coupling unit, it reduces the complexity or cumbersomeness associated with assembly, maintenance, or repair of the light coupling units.

Referencing still to FIG. 11, in some embodiments, device 1100 includes photodetector 1128, which receives at least a portion of the second amplified laser light via optical fiber 1129. Photodetector 1128 can provide measurements of the output power of the second amplified laser light. Photodetector 1128 can be enabled or disabled depending on if measurement of the output power is needed. The second amplified laser light passes through light coupling unit 1106 and is then delivered to other optical components 1120 (e.g., lens, mirrors, etc.) via optical path 1118. Optical path 1118 includes an optical fiber or free-space optical components. The other optical components 1120 may include other components (e.g., polygon mirror, collimation lens, or the like) used in, for example, a LiDAR system.

FIGS. 8-11 illustrate various embodiments of an amplification device that has two amplification stages and a single optical power pump. The single optical power pump provides pump power to the second amplification stage. A portion of the pump power is absorbed by the second amplification stage and used for amplification. Another portion of the pump power unused by the second amplification stage is delivered to the first amplification stage using a fiber-based delivering medium. The fiber-based delivering medium includes, for example, a single-mode optical fiber, a multi-mode optical fiber, a large mode area (LMA) fiber, a double-clad fiber, or the like. The devices shown in FIGS. 8-11 therefore avoid or reduce waste of the pump power because the portion of the pump power unused by the second amplification stage is delivered to the first amplification stage for amplification. The devices thus make efficient use of the pump power. Further, the disclosed devices reduce the number of components compared to a conventional multiple stage pre-amplifier having, for example, two optical power pumps and/or other associated components (e.g., an optical splitter for splitting pump laser light). Reducing the number of components make the device and the overall LiDAR system more robust and reliable. The overall efficiency can thus also be improved and the ASE is effectively suppressed or reduced.

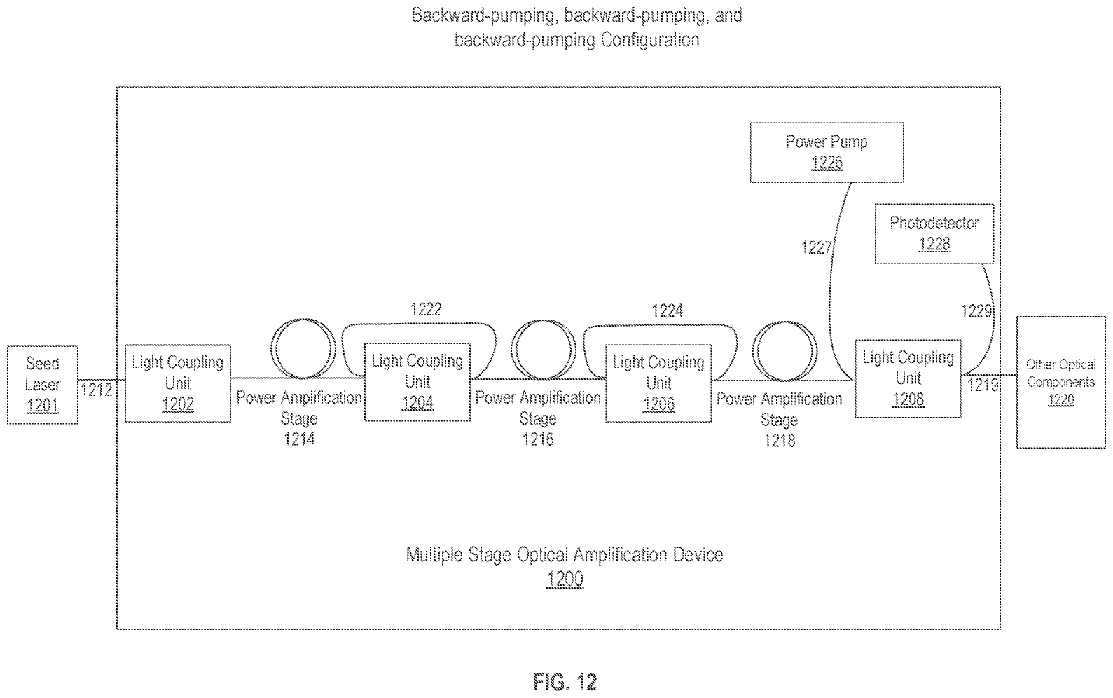

It is understood that a multiple-stage amplification device can have more than two stages. FIG. 12 illustrates a multiple stage optical amplification device 1200 having three amplification stages according to one embodiment. Device 1200 has a backward pumping, backward pumping, and backward pumping configuration, similar to device 900 shown in FIG. 9. Multiple stage optical amplification device 1200 comprises light coupling units 1202, 1204, 1206, and 1208; power amplification stages 1214, 1216, and 1218, a single optical power pump 1226, photodetector 1228, two fiber-based delivering media 1222 and 1224, and optical paths 1212, 1219, 1227, and 1229. Device 1200 is thus a three stage amplification device sharing a single optical power pump. In one embodiment, light coupling unit 1202 is optically coupled to seed laser 1201 via optical path 1212. Seed laser 1201 and optical path 1212 are similar to seed laser 801 and optical path 812 described above, respectively, and are thus not repeatedly described.

In addition to being coupled to seed laser 1201, light coupling unit 1202 is optically coupled to a first end (e.g., the front end) of power amplification stage 1214 as shown in FIG. 12. Thus, light coupling unit 1202 passes the seed laser light to power amplification stage 1214. The second end (e.g., the backend) of power amplification stage 1214 is coupled to light coupling unit 1204. Device 1200 further includes fiber-based delivering medium 1222. The first end of fiber-based delivering medium 1222 is optically coupled to the backend of the first power amplification stage 1214 via light coupling unit 1204. The second end of fiber-based delivering medium 1222 is optically coupled to a first end (e.g., the front end) of the second power amplification stage 1216 via light coupling unit 1204. Light coupling unit 1204 is optically coupled to a first end (e.g., the front end) of power amplification stage 1216. The second end (e.g., the backend) of power amplification stage 1216 is optically coupled to light coupling unit 1206. Device 1200 further includes a fiber-based delivering medium 1224. The first end of fiber-based delivering medium 1224 is optically coupled to the backend of the second power amplification stage 1216 via light coupling unit 1206. The second end of fiber-based delivering medium 1224 is optically coupled to a first end (e.g., the front end) of the third power amplification stage 1218 via light coupling unit 1206. Light coupling unit 1206 is optically coupled to a first end (e.g., the front end) of power amplification stage 1218. The second end (e.g., the backend) of power amplification stage 1218 is optically coupled to an optical power pump 1226 via another light coupling unit 1208.

In device 1200, power amplification stages 1214, 1216, and 1218 each comprises a fiber-based amplification medium such as a rare earth doped medium (e.g., doped with at least one of Yb, Er, Tm, or Nd). The amplification media included in power amplification stages 1214, 1216, and 1218 may be the same or different. For example, each of amplification stages 1214, 1216, and 1218 may comprise a 1550 nm single mode Er-doped fiber-based amplification medium. Optical power pump 1226 can provide pump laser light using, for example, one or more laser diodes. In one example, optical power pump 1226 is a 400 mW single model pump producing pump laser light having a 980 nm wavelength. It is understood that power amplification stages 1214, 1216, and 1218 can include any type of doped medium to produce output light having any desired wavelengths (e.g., 1030 nm, 1064 nm, 1530 nm, 1550 nm, 2 μm, or the like). In addition, optical power pump 1226 can also be configured to provide pump laser light having any desired wavelengths (e.g., 915 nm, 940 nm, 980 nm, 1530 nm, or the like). Further, the fiber-based amplification media 1222 and 1224 can comprise single mode fibers, large mode area (LMA) fibers, double-clad fibers, or the like. The pump laser may have a wavelength that is different from, or the same as, the seed laser provided by seed laser 1201.

Unlike device 700, in which optical power pump 726 is disposed at the front end of the power amplifier, optical power pump 1226 of device 1200 is disposed at the backend of power amplification stage 1218. In this configuration shown in FIG. 12, optical power pump 1226 can provide pump power to all three power amplification stages 1214, 1216, and 1218. As shown in FIG. 12, optical power pump 1226 is optically coupled to the backend of power amplification stage 1218 via light coupling unit 1208. Optical power pump 1226 generates pump laser light to provide pump power. The pump laser light provided by optical power pump 1226 is delivered to light coupling unit 1208 using optical path 1227 (e.g., an optical fiber). Light coupling unit 1208 delivers the pump laser light to power amplification stage 1218 for providing pump power. A portion of the pump power is used in power amplification stage 1218 for amplification and another portion of the pump power is delivered to light coupling unit 1206 in the form of pump laser light. Light coupling unit 1206 then provides at least a portion of the pump power unused by power amplification stage 1218 to the backend of power amplification stage 1216 using fiber-based delivering medium 1224. Again, not all the pump power is used by power amplification stage 1216. Therefore, the portion that is unused is further delivered to power amplification stage 1214 via light coupling unit 1204 and fiber-based delivering medium 1222.

As described above, light coupling unit 1202 passes the seed laser light generated by seed laser 1201 to power amplification stage 1214. Because light coupling unit 1204 is optically coupled to the backend of power amplification stage 1214, the portion of the pump power delivered by fiber-based delivering medium 1222 can then be delivered to power amplification stage 1214. This portion of the pump power can thus be used to amplify the seed laser light that is also delivered to power amplification stage 1214. As a result, power amplification stage 1214 is a first amplification stage that amplifies the seed laser light to generate the first amplified laser light.

Next, light coupling unit 1204 delivers the first amplified laser light to power amplification stage 1216. A portion of the pump power is also delivered to power amplification stage 1216 by fiber-based delivering medium 1224 and light coupling unit 1206. Therefore, this portion of the pump power can be used to amplify the first amplified laser light that is also delivered to power amplification stage 1216. As a result, power amplification stage 1216 is a second amplification stage that amplifies the first amplified laser light to generate the second amplified laser light.

Next, light coupling unit 1206 delivers the second amplified laser light to power amplification stage 1218, which uses a portion of the pump power provided by optical power pump 1226 via light coupling unit 1208. The second amplified laser light is thus further amplified in a similar manner. In particular, a portion of the pump power provided by optical power pump 1226 is absorbed by the doped optical fiber of power amplification stage 1218 to excite dopant ions. The decay of the excited ions from an upper energy level to a lower energy level generates a third amplified laser light having the desired signal wavelength (e.g., 1550 nm).

In one example, about 50-90% (e.g., 70%) of the pump power provided by the optical power pump 1226 is used for the third stage amplification by power amplification stage 1218. The remaining about 10-50% (e.g., 30%) of the pump power provided by optical power pump 1226 is delivered to power amplification stage 1216. Power amplification stage 1216 may use a portion (e.g., 70%) of the received power for amplification. The remaining pump power unused by the second stage amplification is then delivered to the power amplification stage 1214. Thus, the configuration of device 1200 shown in FIG. 12 can use a single optical power pump to provide three stage amplifications, making more efficient use of the pump power and reducing energy waste. Device 1200 also does not require to use a laser light splitter for splitting the pump laser light to be used in two amplification stages, thereby reducing the number of required optical components. Device 1200 also does not require other additional optical components (e.g., pump power strippers), therefore enhancing the hardware integration. The reduced number of optical components enhances the system robustness and reliability, and makes the system more cost efficient.

In one example, the output power of the output signal from device 1200 is about 20-60% higher than a single stage amplifier such as the one shown in FIG. 7. A higher output power enables the light signal to travel to a far-distance object. As a result, a LiDAR device using such a light signal can detect object that is located far away from the device (e.g., more than about 100-250 meters).

Furthermore, because device 1200 has three amplification stages, each stage can have a smaller power gain than that of a single stage amplifier (e.g., amplifier 700 shown in FIG. 7) or any stage in a two stage amplifier, while still obtaining the same output power. In device 1200, because of the smaller power gain, it may facilitate further reducing ASE and improving the signal-to-noise ratio of device 1200. It is understood that device 1200 may be configured such that more or less pump power can be delivered to the first and second power amplification stages and therefore, the output power of the first, second, and third amplification stages may vary.

As described above, device 1200 is configured such that the optical power pump 1226 is disposed at the backend of the amplification stages. The pump power is deliverable to the third power amplification stage (e.g., stage 1218) from the backend of the third power amplification stage, thereby effectively performing backward pumping of the third power amplification stage. And a portion of the pump power (e.g., the portion that is unused by the third power amplification stage) is deliverable to the second power amplification stage (e.g., stage 1216) from the backend of the second power amplification stage, thereby also effectively performing backward pumping of the second power amplification stage. Similarly, a portion of the pump power that is unused by the second power amplification stage is deliverable to the first power amplification stage (e.g., stage 1214) from the backend of the first power amplification stage. Therefore, this configuration is also referred to as a backward-pumping, backward-pumping, and backward-pumping configuration with respect to the first, the second, and the third amplification stages, respectively. It is understood that configurations of a three stage amplification device are not limited that shown in FIG. 12. Any desired configuration may be implemented. For example, the three stage amplification device can have a forward-pumping, backward-pumping, and backward-pumping configuration, a backward-pumping, forward-pumping, and backward-pumping configuration, a forward-pumping, forward-pumping, and backward-pumping configuration, etc.

As also described above, multiple light coupling units 1202, 1204, 1206, and 1208 are used in device 1200. In one embodiment, light coupling unit 1202 includes one or more optical isolators. Light coupling units 1204 and 1206 each includes an assembly of one or more optical isolators and multiple WDMs and/or combiners. Light coupling unit 1206 includes an assembly of one or more WDMs and/or combiners, one or more optical isolators, and a TAP. FIG. 13 shows an example light coupling unit 1310, 1330, and 1340, one or more of which can be used to implement light coupling units 1202, 1204, 1206, and 1208 In one embodiment, light coupling unit 1310 includes one or more optical isolators 1312. Light coupling unit 1340 includes one or more optical isolators 1342 and multiple WDMs and/or combiners 1344 and 1346. Light coupling unit 1330 includes one or more WDMs and/or combiners 1334, one or more isolators 1332, and a TAP 1336. As described above, an optical isolator can pass optical signals from its input to its output but not backward. Thus, the optical isolator prevents undesired feedback or reflection. In one configuration of device 1200, each of light coupling units 1202, 1204, 1206, and 1208 includes an optical isolator. As a result, the seed laser signal, the first amplified laser light generated by power amplification stage 1214, the second amplified laser light generated by power amplification stage 1216, and the third amplified laser light generated by power amplification stage 1218 can only propagate forward, but not backward.

In one configuration of device 1200, light coupling units 1204, 1206, and 1208 can each include one or more WDMs or one or more optical combiners. For example, light coupling unit 1204 includes a first WDM or combiner coupled to power amplification stage 1214 and a second WDM or combiner coupled to power amplification stage 1216. Light coupling unit 1204 can also include an isolator. In one embodiment, both the first and second WDMs/combiners are also coupled to fiber-based delivering medium 1222. Thus, the first WDM/combiner of light coupling unit 1204 can deliver the portion of pump power delivered by fiber-based delivering medium 1222 to power amplification stage 1214. In some embodiments, a WDM and/or combiner in light coupling unit 1204 can pass the first amplified laser light generated by power amplification stage 1214 to power amplification stage 1216 (e.g., via the isolator and the second WDM) for further amplification.

The second WDM and/or combiner of light coupling unit 1204 delivers a portion of the pump laser light that is unused by power amplification stage 1216 to fiber-based delivery medium 1222, thereby providing a portion of the pump power generated by optical power pump 1226 to power amplification stage 1214 (via the first WDM of light coupling unit 1204). In some embodiments, a WDM and/or combiner of light coupling unit 1204 delivers the first amplified laser light generated by power amplification stage 1214 to power amplification stage 1216 for further amplification.

Similarly, light coupling unit 1206 includes a third WDM/combiner coupled to power amplification stage 1216 and a fourth WDM/combiner coupled to power amplification stage 1218. Light coupling unit 1206 can also include one or more isolators. In some embodiments, both the third and fourth WDMs are also coupled to fiber-based delivering medium 1224. Thus, the third WDM of light coupling unit 1206 can deliver the portion of pump power delivered by fiber-based delivering medium 1224 to power amplification stage 1216. A WDM and/or combiner in light coupling unit 1206 can deliver the second amplified laser light generated by power amplification stage 1216 to power amplification stage 1218 (e.g., via the isolator and/or another WDM) for further amplification.

The fourth WDM of light coupling unit 1206 delivers a portion of the pump laser light that is unused by power amplification stage 1218 to fiber-based delivery medium 1224, thereby providing a portion of the pump power generated by optical power pump 1226 to power amplification stage 1216 (via the third WDM of light coupling unit 1206). A WDM and/or combiner of light coupling unit 1206 delivers the second amplified laser light generated by power amplification stage 1216 to power amplification stage 1218 for further amplification. In this manner, the pump power generated by a single optical power pump 1226 is provided to three amplification stages 1214, 1216, and 1218.

In one configuration of device 1200, light coupling unit 1208 can include one or more WDMs and/or one or more optical combiners, one or more optical isolators, and a TAP. Light coupling unit 1208 can be configured to be the same or similar to light coupling unit 806 and is therefore not repeatedly described. Similar to the above-described light coupling units 802, 804, and 806, light coupling units 1202, 1204, 1206, and 1208 can also be assemblies of one or more optical components (e.g., isolator, WDM, combiner, and/or TAP). By assembling multiple optical components within a same light coupling unit, it reduces the complexity or cumbersomeness associated with maintenance or repair of the light coupling units.

Referencing still to FIG. 12, in some embodiments, device 1200 includes photodetector 1228, which receives at least a portion of the third amplified laser light via optical fiber 1229. Photodetector 1228 can provide measurements of the output power of the third amplified laser light. Photodetector 1228 can be enabled or disabled depending on if measurement of the output power is needed. The third amplified laser light passes through light coupling unit 1208 and is then delivered to other optical components 1220 (e.g., lens, mirrors, etc.) via optical path 1219. Optical path 1219 includes an optical fiber or free-space optical components. The other optical components 1220 may include other components (e.g., polygon mirror, collimation lens, or the like) used in, for example, a LiDAR system.

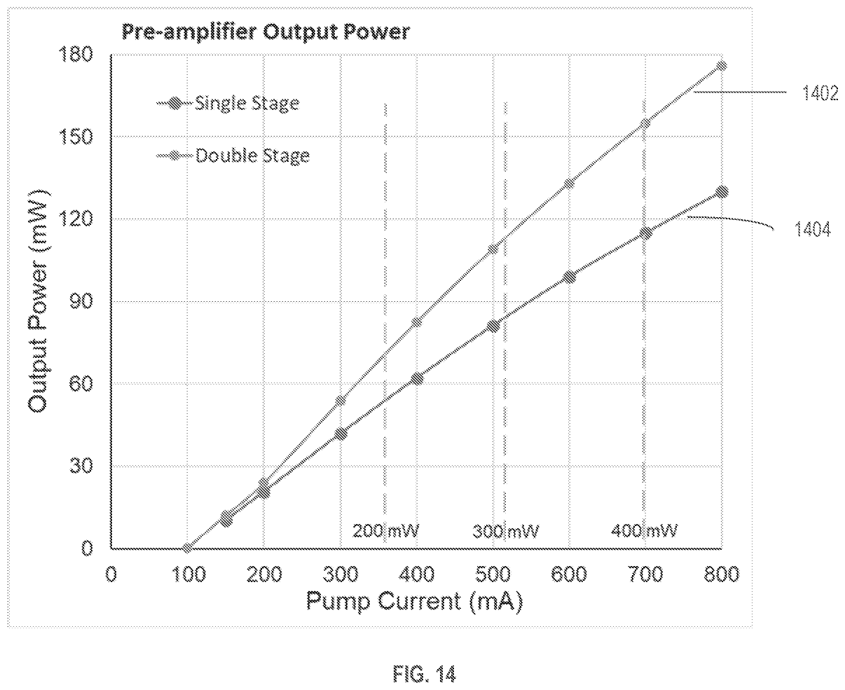

FIG. 14 illustrates an exemplary relation between an output power and a pump current of both a single stage optical amplifier and a multiple stage optical amplification device. In FIG. 14, horizontal axis represents the pump current and the vertical axis represents the output power. Curve 1402 represents the output power-pump current relation of a two stage amplification device (e.g., device 800, 900, 1000, or 1100). Curve 1404 represents the output power-pump current relation of a single stage amplification device (e.g., device 700). FIG. 14 illustrates that if the same pump current is provided to a disclosed two-stage amplification device and a conventional single stage amplification device, the disclosed two-stage amplification device has a higher output power. For example, if the pump current is about 400 mW, the output power of the two-stage amplification device can be about 35% higher than that of the single stage amplification device.

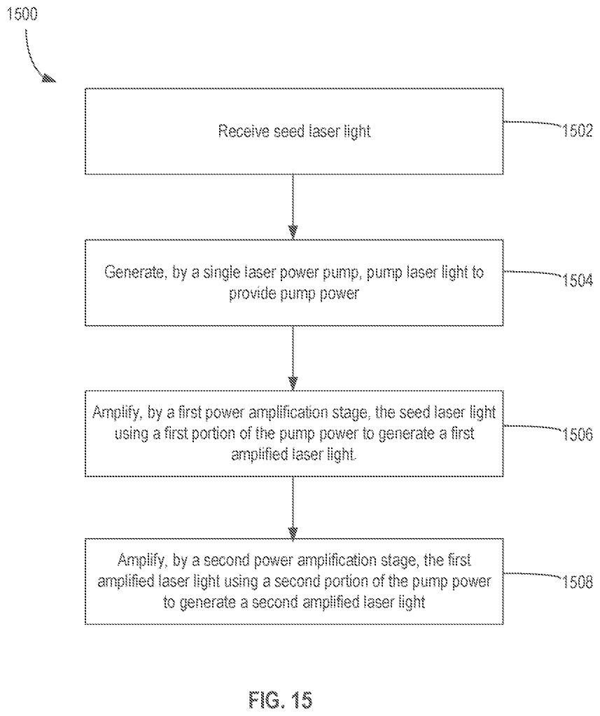

FIG. 15 is a flowchart illustrating a method 1500 for performing multiple stage optical amplification. Method 1500 can be performed by any multiple stage optical amplification devices described above, including devices 800, 900, 1000, 1100, and 1200. As shown in FIG. 15, in step 1502, the multiple stage optical amplification device receives seed laser light. In step 1504, a single optical power pump of the amplification device generates pump laser light to provide pump power. In step 1506, a first power amplification stage (e.g., stage 814, 914, 1014, 1114, or 1214) of the amplification device amplifies the seed laser light using a first portion of the pump power to generate a first amplified laser light. In step 1508, a second power amplification stage (e.g., stage 816, 916, 1016, 1116, or 1216) of the amplification device amplifies the first amplified laser light using a second portion of the pump power to generate a second amplified laser light. For a two-stage amplification device, the second amplified laser light may be the output light signal having a desired wavelength and output power.

In some embodiments, method 1500 further includes steps of (not shown) combining the seed laser light and pump laser light corresponding to the first portion of the pump power to generate combined light; and delivering the combined light to the first power amplification stage. Method 1500 can further include delivering the seed laser light to a first end of the first power amplification stage; and delivering a first portion of the pump laser light corresponding to the first portion of the pump power to a second end of the first power amplification stage. The first end and the second end of the first power amplification stage are different ends of the first power amplification stage.

In some embodiments, method 1500 further includes steps of (not shown) delivering the first amplified laser light to a first end of the second power amplification stage; and delivering the pump laser light to a second end of the second power amplification stage. The first end and the second end of the second power amplification stage are different ends of the second power amplification stage.

In some embodiments, method 1500 further includes steps of (not shown) combining the first amplified laser light and the pump laser light to generate combined light; and delivering the combined light to the second power amplification stage.

In some embodiments, method 1500 further includes steps of (not shown) amplifying, by a third power amplification stage, the second amplified laser light using a third portion of the pump power to generate a third amplified laser light. The second portion of the pump power is delivered from the third power amplification stage to the second power amplification stage to amplify the first amplified laser light.

In some embodiments, method 1500 further includes steps of (not shown) delivering the seed laser light to a first end of the first power amplification stage; and delivering a first portion of the pump laser light corresponding to the first portion of the pump power to a second end of the first power amplification stage. The first end and the second end of the first power amplification stage are different ends of the first power amplification stage. Method 1500 further includes steps of (not shown) delivering the first amplified laser light to a first end of the second power amplification stage; and delivering a second portion of the pump laser light corresponding to the second portion of the pump power to a second end of the second power amplification stage. The first end and the second end of the second power amplification stage are different ends of the second power amplification stage.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A multiple stage optical amplification device in a light detection and ranging (LiDAR) scanning system, comprising:
a first power amplification stage receiving seed laser light and outputting first amplified laser light;
a second power amplification stage receiving the first amplified laser light and outputting a second amplified laser light; and
a single optical power pump coupled to the second power amplification stage, the second power amplification stage being configured to amplify the first amplified laser light to generate the second amplified laser light, wherein a first portion of pump power provided by the optical power pump is deliverable to the first power amplification stage to amplify the seed laser light.

2. The device of claim 1, further comprising:
a fiber-based delivering medium; and
a first light coupling unit optically coupled to:
the seed laser light,
a first end of the first power amplification stage, and
a first end of a fiber-based delivering medium,
wherein the first portion of pump power is deliverable to the first power amplification stage via the first light coupling unit and the fiber-based delivering medium.

3. The device of claim 2, further comprising:
a second light coupling unit optically coupled to:
a second end of the first power amplification stage,
a first end of the second power amplification stage, and
a second end of the fiber-based delivering medium,
wherein the first portion of pump power is deliverable to the first power amplification stage further via the second light coupling unit.

4. The device of claim 3, further comprising:
a third light coupling unit optically coupled to:
a second end of the second power amplification stage, and
the optical power pump,
wherein the pump power provided by the optical power pump is deliverable to the second power amplification stage via the third light coupling unit.

5. The device of claim 4, wherein each of the first light coupling unit, the second light coupling unit, and the third light coupling unit comprises a wavelength division multiplexer (WDM) and an optical isolator.

6. The device of claim 4, wherein the third light coupling unit comprises an optical Traffic Access Point (TAP) optically coupled to a photodetector, the optical TAP facilitates monitoring an output of the multi-stage laser amplification device.

7. The device of claim 1, further comprising:
a first light coupling unit optically coupled to:
the seed laser light, and
a first end of the first power amplification stage.

8. The device of claim 7, further comprising:
a fiber-based delivering medium; and
a second light coupling unit optically coupled to:
a second end of the first power amplification stage,
a first end of the second power amplification stage, and
a first end and a second end of the fiber-based delivering medium,
wherein the first portion of pump power is deliverable to the first power amplification stage via the second light coupling unit and the fiber-based delivering medium.

9. The device of claim 8, further comprising:
a third light coupling unit optically coupled to:
a second end of the second power amplification stage, and
the optical power pump,
wherein the pump power provided by the optical power pump is deliverable to the second power amplification stage via the third light coupling unit.

10. The device of claim 9, wherein the second light coupling unit comprises:
a first wavelength division multiplexers (WDM) optically coupled to the first end of the fiber-based delivering medium; and
a second wavelength division multiplexers (WDM) optically coupled to the second end of the fiber-based delivering medium.

11. The device of claim 10, wherein the third light coupling unit comprises:
a third wavelength division multiplexers (WDM); and
an optical Traffic Access Point (TAP) optically coupled to a photodetector, the optical TAP facilitates monitoring an output of the multi-stage laser amplification device.

12. The device of claim 9, wherein each of the first light coupling unit, the second light coupling unit, and the third light coupling unit comprises an optical isolator.

13. The device of claim 1, further comprising:
a fiber-based delivering medium; and
a first light coupling unit optically coupled to:
the seed laser light,
a first end of a first power amplification stage, and
a first end of the fiber-based delivering medium,
wherein the first portion of pump power is deliverable to the first power amplification stage via the first light coupling unit and the fiber-based delivering medium.

14. The device of claim 13, further comprising:
a second light coupling unit optically coupled to:
a second end of the first power amplification stage,
a first end of the second power amplification stage, and
the optical power pump,
wherein the pump power provided by the optical power pump is deliverable to the second power amplification stage via the second light coupling unit.

15. The device of claim 14, further comprising:
a third light coupling unit optically coupled to:
a second end of the second power amplification stage, and
a second end of the fiber-based delivering medium,
wherein the first portion of pump power is deliverable to the first power amplification stage further via the third light coupling unit.

16. The device of claim 15, wherein each of the first light coupling unit, the second light coupling unit, and the third light coupling unit comprises a wavelength division multiplexer (WDM) and an optical isolator.

17. The device of claim 15, wherein the third light coupling unit comprises an optical Traffic Access Point (TAP) optically coupled to a photodetector, the optical TAP facilitates monitoring an output of the multi-stage laser amplification device.

18. The device of claim 1, wherein the first power amplification stage and second power amplification stage comprise fiber-based amplification medium.

19. The device of claim 1, further comprising:
a plurality of light coupling units configured to optically couple the first power amplification stage, the second power amplification stage, and the optical power pump from one another,
wherein at least one of the plurality of light coupling units comprises an assembly of one or more optical isolators and one or more wavelength division multiplexers (WDMs).

20. The device of claim 1, wherein a power gain of the first power amplification stage is less than a power gain of the second power amplification stage.

21. The device of claim 1, further comprising:
a first light coupling unit optically coupled to:
the seed laser light, and
a first end of the first power amplification stage.
a fiber-based delivering medium; and
a second light coupling unit optically coupled to:
a second end of the first power amplification stage, and
a first end of the fiber-based delivering medium,
wherein the first portion of pump power is deliverable to the first power amplification stage via the second light coupling unit and the fiber-based delivering medium.

22. A multi-stage laser amplification device in a light detection and ranging (LiDAR) scanning system, comprising:
a first power amplification stage receiving a seed laser light and outputting a first amplified laser light;
a second power amplification stage receiving the first amplified laser light and outputting a second amplified laser light;
a third power amplification stage receiving the second amplified laser light and outputting a third amplified laser light; and
a single optical power pump coupled to the third power amplification stage, the third power amplification stage amplifying the second amplified laser light, wherein a first portion of pump power provided by the optical power pump is deliverable to the first power amplification stage.

23. The device of claim 22, further comprising:
a first light coupling unit optically coupled to:
the seed laser light, and
a first end of the first power amplification stage.

24. The device of claim 23, further comprising:
a first fiber-based delivering medium; and
a second light coupling unit optically coupled to:
a second end of the first power amplification stage,
a first end of the second power amplification stage, and
a first end and a second end of the first fiber-based delivering medium,
wherein the first portion of pump power is deliverable to the first power amplification stage at least via the second light coupling unit and the first fiber-based delivering medium.

25. The device of claim 24, further comprising:
a second fiber-based delivering medium; and
a third light coupling unit optically coupled to:
a second end of the second power amplification stage,
a first end of the third power amplification stage, and
a first end and a second end of the second fiber-based delivering medium,
wherein the first portion of pump power is deliverable to the first power amplification stage further via the third light coupling unit and the second fiber-based delivering medium.

26. The device of claim 25, further comprising:
a fourth light coupling unit optically coupled to:
a second end of the third power amplification stage, and
the optical power pump,
wherein the pump power provided by the optical power pump is deliverable to the third power amplification stage via the fourth light coupling unit.

27. The device of claim 25, wherein the second light coupling unit comprises:
a first wavelength division multiplexers (WDM) optically coupled to the first end of the first fiber-based delivering medium; and
a second wavelength division multiplexers (WDM) optically coupled to the second end of the first fiber-based delivering medium.

28. The device of claim 25, wherein the third light coupling unit comprises:
a third wavelength division multiplexers (WDM) optically coupled to the first end of the second fiber-based delivering medium; and
a fourth wavelength division multiplexers (WDM) optically coupled to the second end of the second fiber-based delivering medium.

29. The device of claim 25, wherein the third light coupling unit comprises:
a fifth wavelength division multiplexers (WDM) and a fiber optical coupler optically coupled to a photodetector.

30. A method performed by a multiple stage optical amplification device for performing optical amplification, the method comprises:
receiving seed laser light;
generating, by a single optical power pump, pump laser light to provide pump power;
amplifying, by a first power amplification stage, the seed laser light using a first portion of the pump power to generate a first amplified laser light;
amplifying, by a second power amplification stage, the first amplified laser light using a second portion of the pump power to generate a second amplified laser light, wherein the first portion of the pump power is delivered from the second power amplification stage to the first power amplification stage to amplify the seed laser light.

31. The method of claim 30, further comprising:
combining the seed laser light and pump laser light corresponding to the first portion of the pump power to generate combined light; and
delivering the combined light to the first power amplification stage.

32. The method of claim 30, further comprising:
delivering the seed laser light to a first end of the first power amplification stage; and
delivering a first portion of the pump laser light corresponding to the first portion of the pump power to a second end of the first power amplification stage, wherein the first end and the second end of the first power amplification stage are different ends of the first power amplification stage.

33. The method of claim 30, further comprising:
delivering the first amplified laser light to a first end of the second power amplification stage; and
delivering the pump laser light to a second end of the second power amplification stage, wherein the first end and the second end of the second power amplification stage are different ends of the second power amplification stage.

34. The method of claim 30, further comprising:
combining the first amplified laser light and the pump laser light to generate combined light; and
delivering the combined light to the second power amplification stage.

35. The method of claim 30, further comprising:
amplifying, by a third power amplification stage, the second amplified laser light using a third portion of the pump power to generate a third amplified laser light, wherein the second portion of the pump power is delivered from the third power amplification stage to the second power amplification stage to amplify the first amplified laser light.

36. The method of claim 35, further comprising:
delivering the seed laser light to a first end of the first power amplification stage;
delivering a first portion of the pump laser light corresponding to the first portion of the pump power to a second end of the first power amplification stage, wherein the first end and the second end of the first power amplification stage are different ends of the first power amplification stage;
delivering the first amplified laser light to a first end of the second power amplification stage; and
delivering a second portion of the pump laser light corresponding to the second portion of the pump power to a second end of the second power amplification stage, wherein the first end and the second end of the second power amplification stage are different ends of the second power amplification stage.
